(19) United States
(12) Patent Application Publication
(10) Pub. No.: US 2026/0101887 A1
(43) Pub. Date: Apr. 16, 2026

(54) AN EMULSIFIABLE CONCENTRATE HAVING A LACTONE-BASED SOLVENT SYSTEM

(71) Applicant: BASF SE, Ludwigshafen Am Rhein (DE)

(72) Inventors: Adam BLANAZS, Ludwigshafen (DE); Peter HOFER, Ludwigshafen (DE); Calvin Michael SCHALOSKE, Ludwigshafen (DE)

(21) Appl. No.: 19/113,021

(22) PCT Filed: Oct. 5, 2023
(86) PCT No.: PCT/EP23/77571

§ 371 Date: Mar. 19, 2025

(30) Foreign Application Priority Data
Oct. 7, 2022 (EP) 22200351.9

(51) Int. Cl. A01N 25/04; A01N 43/88

(52) U.S. Cl. CPC A01N 25/04; A01N 43/88

(57) ABSTRACT

Described herein are an emulsifiable concentrate (EC) including one or more pesticides, one or more emulsifiers and certain lactone-derived solvents, an emulsion-in-water (EW) formulation formed from the emulsifiable concentrate (EC), and a method of using the certain lactone-derived solvents as a solvent in an agrochemical emulsifiable concentrate.

### FIELD OF THE INVENTION

The present invention is directed to an emulsifiable concentrate (EC) comprising one or more pesticides, one or more emulsifiers and certain lactone-derived solvents, to an emulsion-in-water (EW) formulation formed from said emulsifiable concentrate (EC), and to the use of the certain lactone-derived solvents as a solvent in an agrochemical emulsifiable concentrate.

### BACKGROUND TO THE INVENTION

When preparing agrochemical formulations, it is usually required to dissolve the agrochemically active ingredient, e.g. one or more pesticides in a solvent, which is then diluted in a larger volume of water in order for it to be applied in the form of a fine spray. Alternatively, it may be necessary to dilute the agrochemically active ingredient in a solution and load it onto a seed or solid carrier. Whilst some agrochemically active ingredients are salts and thus highly water-soluble, allowing for simply dissolution, many other non-ionic agrochemically active ingredients are hydrophobic and not at all water-soluble.

In the case of active ingredients that are not water-soluble, it is normally necessary to dissolve the formulation in a water-immiscible solvent and add one or more surfactants, so that the solution will form an oil-in-water emulsion, when added to water. Such a formulation is called an Emulsifiable Concentrate (EC) formulation. Alternatively, the water-immiscible solution comprising active ingredient can be pre-emulsified in water in a concentrated form. Such a formulation is called an Emulsion-in-water (EW) formulation.

Water-immiscible solvents commonly used for EC and EW formulations include, but are not limited to, aromatic hydrocarbons such as the SOLVESSO® series, paraffinic hydrocarbons such as the EXXSOL® range, ester solvents such as the EXXATE® range, all of which are manufactured by EXXONMOBIL, and ester solvents such as methyloleate. Further, solvents that are water-immiscible at high concentration include cyclic hydrocarbons, such as cyclohexanone and isophorone. In more recent times, solvents that exhibit improved toxicity and reduced flammability profiles have been used. These include the dibasic ester solvents of long chain di-acids having from 8-16 carbon units, which are usually methyl ester derivatives, and fatty acid amide solvents, examples of which are the dimethylamide and morpholineamide derivatives of C₆-C₁₆ fatty acids. Mono-alkylene carbonates such as ethylene, propylene and butylene carbonates, also find use as co-solvents.

Combinations of water-immiscible solvents with highly polar water-miscible co-solvents such as N-methyl pyrrolidinone (NMP), dimethylsulphoxide, dimethylisosorbide, monoethylene glycol, monopropylene glycol and various glycol ethers have been used in the past to achieve physical stability of the EC formulation, particularly if crystallization of the active ingredient occurs at below ambient temperature. However, the use of such solvent combinations often leads to the problem of crystallization in the diluted formulation.

There exists in the pesticide industry a great desire to find alternatives to currently used solvents such as fatty acid amides, isophorone, methyl butyl ketone (MBK), NMP, etc. which may be expensive, difficult to source and/or are environmentally unattractive due to their inherent phytotoxicity, toxicity (e.g. teratogenicity) or regulatory status.

Fatty acid esters have been used in emulsifiable concentrates and are known to be less hazardous/odorous than the fatty acid amides; however, they are typically only able to achieve moderate to low solubility across the broad range of commercially important pesticides.

As such, there remains a need for solvents suitable for use in emulsifiable concentrate formulations and emulsion-in-water formulations, which combine low phytotoxicity and generally benign (e.g. non-irritant) properties with high solubility for a range of commonly employed agrochemical active ingredients.

### SUMMARY OF THE INVENTION

The finding of the present invention is that certain lactone-derived solvents combine low phytotoxicity and generally benign (e.g. non-irritant) properties with high solubility for a range of agrochemical active ingredients.

In a first aspect, the present invention is directed to an emulsifiable concentrate (EC) comprising one or more pesticides, one or more emulsifiers and one or more solvents, wherein at least one of the one or more solvents has a structure according to formula (I):

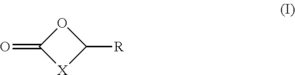

wherein X is selected from —CR′₂CR′₂—, —CR′═CR′—, —CR′₂CR′₂CR′₂—, and —CR′═CR′CR′₂—, R is selected from linear and branched C₁ to C₁₅ alkyl or alkenyl groups, and each instance of R′ is independently selected from H, Me and Et.

In a further aspect, the present invention is directed to an emulsion-in-water (EW) formulation, comprising an aqueous phase and a non-aqueous phase, wherein the non-aqueous phase is the emulsifiable concentrate (EC) of the first aspect.

In another aspect, the present invention is directed to a use of a compound having a structure according to formula (I):

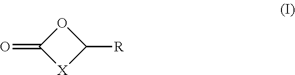

wherein X is selected from —CR′₂CR′₂—, —CR′═CR′—, —CR′₂CR′₂CR′₂—, and —CR′═CR′CR′₂—, R is selected from linear and branched C₁ to C₁₅ alkyl or alkenyl groups, and each instance of R′ is independently selected from H, Me and Et, as a solvent in an agrochemical emulsifiable concentrate, preferably the emulsifiable concentrate (EC) according to the first aspect.

In a final aspect, the present invention is directed to a use of the emulsion-in-water (EW) formulation according to the further aspect described above for treating plants, thereby maintaining plant health, without causing plant damage.

### Definitions

Emulsifiable concentrates are typically optically transparent oily liquid formulations that are prepared by dissolving a certain amount of pesticide in organic solvents (such as benzene, toluene, xylene, and solvent oil), which may also contain surfactants (i.e. emulsifiers) and other additives. These concentrates are suitable for dispersion within an aqueous phase to form an emulsion-in-water formulation. Emulsifiable concentrates must be monophasic, i.e. the pesticide and any emulsifiers must be completely soluble in the organic solvent at the concentrations used.

An emulsion is a mixture of two or more liquids that are normally immiscible, wherein one liquid forms a dispersed phase, suspended as tiny droplets within the other liquid, which is known as the continuous phase. Emulsions are typically referred to as oil-in-water (i.e. the water is the continuous phase) or water-in-oil (i.e. the oil is the continuous phase). In the context of agrochemical formulations, oil-in-water emulsions, known as emulsion-in-water formulations are often used to disperse hydrophobic pesticides across fields of crop plants.

The U.S Environmental Protection Agency (EPA) defines a pesticide as “any substance or mixture of substances intended for preventing, destroying, repelling, or mitigating any pest”. A pesticide may be a chemical substance or biological agent (such as a virus or bacteria) used against pests including insects, plant pathogens, weeds, molluscs, birds, mammals, fish, nematodes (roundworms) and microbes that compete with humans for food, destroy property, spread disease or are a nuisance. In the context of agrochemical formulations, pesticides are used to actively target pests, typically fungi, insects, and/or weed plants, without unduly harming the crop plant.

Phytotoxicity describes any adverse effects on plant growth, physiology or metabolism caused by a chemical or biological substance. In the context of agrochemical formulations, it is desired to avoid phytotoxic properties in order that the health of the crop plant is not impacted.

In the context of the present invention, alkyl refers to linear and branched chains alkyl chains, whilst aryl refers to any aromatic carbocyclic ring system, being either a single ring, for example phenyl group or a fused ring system, for example a naphthyl group or an anthracenyl group.

A lactone is a cyclic carboxylic ester, i.e. a hydrocarbon ring containing a —(C═O)—O— moiety. Lactones are typically classified by their ring size. α-lactones (alpha-lactones) have a 3-membered ring, β-lactones (beta-lactones) have a 4-membered ring, γ-lactones (gamma-lactones) have a 5-membered ring, δ-lactones (delta-lactones) have a 6-membered ring, whilst ε-lactones (epsilon-lactones) have a 7-membered ring. Of these lactones, gamma-lactones and delta-lactones are the most stable and the most common.

### DETAILED DESCRIPTION

In a first aspect, the present invention is directed to an emulsifiable concentrate (EC) comprising one or more pesticides, one or more emulsifiers and one or more solvents, wherein at least one of the one or more solvents has a structure according to formula (I):

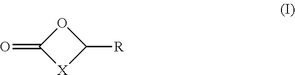

wherein X is selected from —CR′₂CR′₂—, —CR′═CR′—, —CR′₂CR′₂CR′₂—, and —CR′═CR′CR′₂—, R is selected from linear and branched C₁ to C₁₅ alkyl or alkenyl groups, and each instance of R′ is independently selected from H, Me and Et.

### The Solvent

One essential component of the emulsifiable concentrate (EC) is one or more solvents.

At least one of the one or more solvents according to the present invention has a structure according to formula (I):

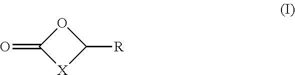

wherein X is selected from —CR′₂CR′₂—, —CR′═CR′—, —CR′₂CR′₂CR′₂—, and —CR′═CR′CR′₂—, R is selected from linear and branched C₁ to C₁₅ alkyl or alkenyl groups, and each instance of R′ is independently selected from H, Me and Et.

In its broadest form, R is selected from linear and branched C₁ to C₁₅ alkyl or alkenyl groups. It is, however, preferred that R is selected from linear and branched C₁ to C₁₅ alkyl groups, more preferably from C₂ to C₁₂ alkyl groups, yet more preferably from C₃ to C₁₀ alkyl groups, most preferably from C₄ to C₈ alkyl groups.

Particularly preferred embodiments of R include n-butyl, n-pentyl, n-hexyl, n-heptyl, n-octyl, s-pentyl, s-hexyl, s-heptyl, and s-octyl, most particularly n-butyl, n-pentyl, n-hexyl, n-heptyl, n-octyl, and s-pentyl.

In the broadest form, X is selected from —CR′₂CR′₂—, —CR′═CR′—, —CR′₂CR′₂CR′₂—, and —CR′═CR′CR′₂—. In the above structure, the left hand end of the X moiety is bonded directly to the carbonyl group, whilst the right hand end of the X moiety is bonded directly to the CHR group. This means that in the case of X═—CR′═CR′CR′₂— the lactone is a stable α,β-unsaturated delta-lactone, rather than an unstable β,γ-unsaturated delta-lactone.

Within each definition of X, each instance of R′ is independently selected from H, Me and Et. It is preferred that each instance of R′ is independently selected from H and Me. In one particularly preferred embodiment, each instance of R′ is H. In an alternative embodiment, one instance of R′ is Me, whilst every other instance of R′ is H. In yet a further alternative embodiment, two instances of R′ are Me, whilst every other instance of R′ is H.

It is particularly preferred that X is selected from —CH₂CH₂—, —CH(Me) CH₂—, —CH₂CH(Me)—, and —CH₂CH₂CH₂—, more preferably from —CH₂CH₂—, —CH₂CH(Me)—, and —CH₂CH₂CH₂—.

For the reasons as explained above regarding which end of the X moiety is bonded to the carbonyl group, the structure having X═—CH(Me) CH₂-represents an α-methylated gamma-lactone, whilst the structure having X═—CH₂CH(Me)—represents a β-methylated gamma-lactone.

In one particularly preferred embodiment, the structure according to formula (I) is a gamma-lactone.

In the gamma-lactone according to formula (I), X is preferably selected from —CH₂CH₂—, —CH(Me) CH₂—, and —CH₂CH(Me)—, more preferably from —CH₂CH₂— and —CH₂CH(Me)—.

Particularly preferred gamma-lactones include gamma-octalactone, gamma-nonalactone, gamma-decalactone, gamma-undecalactone, gamma-dodecalactone, beta-methyl-gamma-octalactone, delta-methyl-gamma-octalactone, and beta, delta-dimethyl-gamma-octalactone.

In an alternative particularly preferred embodiment, the structure according to formula (I) is a delta-lactone.

In the delta-lactone according to formula (I), X is preferably-CH₂CH₂CH₂—.

Particularly preferred delta-lactones include delta-nonalactone, delta-decalactone, delta-dodecalactone, and delta-tridecalactone.

In one particularly preferred embodiment, the solvent having a structure according to formula (I) has 8 or more carbon atoms.

Solvents having a structure according to formula (I) have a further advantage of having a pleasant smell. For example, gamma-nonalactone has a coconut odor, gamma-decalactone has a peach-like odor, and delta-decalactone has a creamy peach-like odor. These odors mean that the resulting emulsifiable concentrates (EC) and emulsions made therefrom are more pleasant to be used than many commercial amide-containing emulsifiable concentrate solvents, which typically have unpleasant fishy smells.

It is preferred that the solvent has a low water solubility, ensuring that an emulsion is formed, rather than a solution.

As such, it is preferred that the solvent has a water solubility of less than 2.0% w/w, more preferably of less than 1.0% w/w, most preferably of less than 0.5% w/w.

It is also preferred that the solvent has low phytotoxicity. This means that the presence of the solvent in the emulsifiable concentrate (EC), and in any emulsion-in-water (EW) formulations formed therefrom, does not cause plant damage, more specifically does not cause plant damage to soya plants.

In particular, it is preferred that the solvent has low phytotoxicity, wherein low phytotoxicity is defined as being when an emulsion containing 99.0% w/w, relative to the total weight of the emulsion, of water and 1.0% w/w, relative to the total weight of the emulsion, of a non-aqueous phase containing 90% w/w of the solvent, 7.5% w/w castor oil ethoxylate and 2.5% w/w of calcium dodecylbenzenesulfonate, each relative to the total weight of the non-aqueous phase, causes at no greater plant damage than an aqueous solution of 0.075% w/w castor oil ethoxylate and 0.025% w/w of calcium dodecylbenzenesulfonate, each relative to the total weight of the aqueous solution, when measured 14 days after application to soya plants at an application rate of 200 L per hectare.

This is especially important for agrochemical emulsifiable concentrates, since it improves the specificity of the resultant emulsion-in-water, when applied to crop plants. The pesticides can actively target the relevant pest (e.g. insects, fungus or weed plants), whilst the crop plant is not adversely affected.

The total content of solvents with a structure according to formula (I) is preferably in the range from 10 to 85% w/w, more preferably from 15 to 75% w/w, most preferably from 25 to 60% w/w, relative to the total weight of the emulsifiable concentrate (EC).

### The One or More Pesticides

Another essential component of the emulsifiable concentrate (EC) is one or more pesticides.

The one or more pesticides of the present invention are not limited.

A pesticide is generally a chemical or biological agent (such as pesticidal active ingredient, compound, composition, virus, bacterium, antimicrobial, or disinfectant) that through its effect deters, incapacitates, kills or otherwise discourages pests. Target pests can include insects, plant pathogens, weeds, mollusks, birds, mammals, fish, nematodes (roundworms), and microbes that destroy property, cause nuisance, spread disease or are vectors for disease. The term “pesticide” includes also plant growth regulators that alter the expected growth, flowering, or reproduction rate of plants; defoliants that cause leaves or other foliage to drop from a plant, usually to facilitate harvest; desiccants that promote drying of living tissues, such as unwanted plant tops; plant activators that activate plant physiology for defense of against certain pests; safeners that reduce unwanted herbicidal action of pesticides on crop plants; and plant growth promoters that affect plant physiology e.g. to increase plant growth, biomass, yield or any other quality parameter of the harvestable goods of a crop plant.

The following lists of pesticides that are suitable for use in emulsifiable concentrates of the invention, is intended to illustrate the possible combinations but does not limit them:

### A) Respiration Inhibitors

inhibitors of complex III at Qo site: azoxystrobin, coumethoxystrobin, coumoxystrobin, dimoxystrobin, enestroburin, fenaminstrobin, fenoxystrobin/flufenoxystrobin, fluoxastrobin, kresoxim-methyl, mandestrobin, metominostrobin, orysastrobin, picoxystrobin, pyraclostrobin, pyrametostrobin, pyraoxystrobin, trifloxystrobin, pyribencarb, triclopyricarb/chlorodincarb, famoxadone, fenamidone, pyriminostrobin, bifujunzhi, metyltetraprole;
inhibitors of complex III at Qi site: cyazofamid, amisulbrom, fenpicoxamid, florylpicoxamid, metarylpicoxamid;
inhibitors of complex II: benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, pydiflumetofen, pyraziflumid, sedaxane, tecloftalam, thifluzamide, inpyrfluxam, pyrapropoyne, fluindapyr, isoflucypram, cyclobutrifluram;
other respiration inhibitors: diflumetorim; nitrophenyl derivates: binapacryl, dinobuton, dinocap, fluazinam, meptyldinocap; ferimzone; organometal compounds: fentin salts, e.g. fentin-acetate, fentin chloride or fentin hydroxide; silthiofam;
quinone outside inhibitor stigmatellin binding type: ametoctradin;

### B) Sterol Biosynthesis Inhibitors (SBI Fungicides)

C14 demethylase inhibitors: triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, fluoxytioconazole, ipfentrifluconazole, mefentrifluconazole; imidazoles: imazalil, pefurazoate, prochloraz, triflumizol; pyrimidines, pyridines, piperazines: fenarimol, pyrifenox, triforine;
Delta14-reductase inhibitors: aldimorph, dodemorph, dodemorph-acetate, fenpropimorph, tridemorph, fenpropidin, piperalin, spiroxamine;
Inhibitors of 3-keto reductase: fenhexamid, fenpyrazamine;
other Sterol biosynthesis inhibitors: chlorphenomizole;

### C) Nucleic Acid Synthesis Inhibitors

RNA polymerase I inhibitors: benalaxyl, benalaxyl-M, kiralaxyl, metalaxyl, metalaxyl-M, ofurace, oxadixyl;
other nucleic acid synthesis inhibitors: hymexazole, octhilinone, oxolinic acid, bupirimate, 5-fluorocytosine, ipflufenoquin, quinofumelin;

### D) Inhibitors of Cell Division and Cytoskeleton

tubulin polymerization inhibitors: benomyl, carbendazim, fuberidazole, thiabendazole, thiophanate-methyl, pyridachlometyl;
other cell division inhibitors: diethofencarb, ethaboxam, pencycuron, fluopicolide, zoxamide, metrafenone, pyriofenone, phenamacril, fluopimomide;

### E) Inhibitors of Amino Acid and Protein Synthesis

methionine synthesis inhibitors: cyprodinil, mepanipyrim, pyrimethanil;
protein synthesis inhibitors: blasticidin-S, kasugamycin, kasugamycin hydrochloride-hydrate, mildiomycin, streptomycin, oxytetracyclin;

### F) Signal Transduction Inhibitors

MAP/histidine kinase inhibitors: fluoroimide, iprodione, procymidone, vinclozolin, fludioxonil;
mechanism unknown: quinoxyfen, proquinazid;

### G) Lipid and Membrane Synthesis Inhibitors

Phospholipid biosynthesis inhibitors: edifenphos, iprobenfos, pyrazophos, isoprothiolane;
lipid peroxidation: dicloran, quintozene, tecnazene, tolclofos-methyl, biphenyl, chloroneb, etridiazole;
compounds affecting cell membrane permeability and fatty acids: propamocarb;
inhibitors of oxysterol binding protein: oxathiapiprolin, fluoxapiprolin;
   H) Inhibitors with Multi Site Action
inorganic active substances: Bordeaux mixture, copper, copper acetate, copper hydroxide, copper oxychloride, basic copper sulfate, sulfur;
thio- and dithiocarbamates: ferbam, mancozeb, maneb, metam, metiram, propineb, thiram, zineb, ziram;
organochlorine compounds: anilazine, chlorothalonil, captafol, captan, folpet, dichlofluanid, dichlorophen, hexachlorobenzene, pentachlorophenol and its salts, phthalide, tolylfluanid;
guanidines and others: guanidine, dodine, dodine free bas, guazatine, guazatine-acetate, iminoctadine, iminoctadine-triacetate, iminoctadine-tris(albesilate), dithianon, fluoroimide, methasulfocarb, chinomethionat;

### 1) Cell Wall Synthesis Inhibitors

inhibitors of glucan synthesis: validamycin, polyoxin B;
melanin synthesis inhibitors: pyroquilon, tricyclazole, carpropamid, dicyclomet, fenoxanil, tolprocarb;
cellulose synthase inhibitors: dimethomorph, flumorph, mandipropamid, pyrimorph, benthiavalicarb, iprovalicarb, valifenalate;

### J) Plant Defence Inducers

acibenzolar-S-methyl, probenazol, isotianil, tiadinil, prohexadione-calcium; phosphonates: fosetyl, fosetyl-aluminum, phosphorous acid and its salts, calcium phosphonate, potassium phosphonate, potassium or sodium bicarbonate, dichlobentiazox;

### K) Unknown Mode of Action

bronopol, cyflufenamid, cymoxanil, dazomet, debacarb, diclocymet, diclomezine, difenzoquat, difenzoquat-methylsulfate, diphenylamine, fenitropan, fenpyrazamine, flumetover, flumetylsulforim, flusulfamide, flutianil, harpin, nitrapyrine, nitrothal-isopropyl, oxin-copper, seboctylamine, tebufloquin, tecloftalam, triazoxide, pyrisoxazole, benzisothiazolinone, bromothalonil, aminopyrifen, flufenoxadiazam;

### L) Biopesticides

L1) Microbial pesticides with fungicidal, bactericidal, viricidal and/or plant defense activator activity: Ampelomyces quisqualis, Aspergillus flavus, Aureobasidium pullulans, Bacillus altitudinis, B. amyloliquefaciens, B. amyloliquefaciens ssp. plantarum (also referred to as B. velezensis), B. megaterium, B. mojavensis, B. mycoides, B. pumilus, B. simplex, B. solisalsi, B. subtilis, B. subtilis var. amyloliquefaciens, B. velezensis, Candida oleo-phila, C. saitoana, Clavibacter michiganensis (bacteriophages), Coniothyrium minitans, Cryphonectria parasitica, Cryptococcus albidus, Dilophosphora alopecuri, Fusarium oxysporum, Clonostachys rosea f. catenulate (also named Gliocladium catenulatum), Gliocladium roseum, Lysobacter antibioticus, L. enzymogenes, Metschnikowia fructi-cola, Microdochium dimerum, Microsphaeropsis ochracea, Muscodor albus, Paeni-Bacillus alvei, Paenibacillus epiphyticus, P. polymyxa, Pantoea vagans, Penicillium bilaiae, Phlebiopsis gigantea, Pseudomonas sp., Pseudomonas chloraphis, Pseudo-zyma flocculosa, Pichia anomala, Pythium oligandrum, Sphaerodes mycoparasitica, Streptomyces griseoviridis, S. lydicus, S. violaceusniger, Talaromyces flavus, Tricho-derma asperelloides, T. asperellum, T. atroviride, T. fertile, T. gamsii, T. hamatum, T. harzianum, T. polysporum, T. stromaticum, T. virens, T. viride, Typhula phacorrhiza, Ulocladium oudemansii, Verticillium dahlia, zucchini yellow mosaic virus (avirulent strain);
L2) Biochemical pesticides with fungicidal, bactericidal, viricidal and/or plant defense activator activity: harpin protein, Reynoutria sachalinensis extract;
L3) Microbial pesticides with insecticidal, acaricidal, molluscidal and/or nematicidal activity: Agrobacterium radiobacter, Bacillus cereus, B. firmus, B. thuringiensis, B. thuringiensis ssp. aizawai, B. t. ssp. israelensis, B. t. ssp. galleriae, B. t. ssp. kurstaki, B. t. ssp. tene-brionis, Beauveria bassiana, B. brongniartii, Burkholderia spp., Chromobacterium sub-tsugae, Cydia pomonella granulovirus, Cryptophlebia leucotreta granulovirus, Flavobacterium spp., Helicoverpa armigera nucleopolyhedrovirus, Helicoverpa zea nucleopolyhedrovirus, Helicoverpa zea single capsid nucleopolyhedrovirus, Heterorhabditis bacteriophora, Isaria fumosorosea, Lecanicillium longisporum, L. muscarium, Metarhizium anisopliae, M. anisopliae var. anisopliae, M. anisopliae var. acridum, Nomuraea rileyi, Paecilomyces fumosoroseus, P. lilacinus, Paenibacillus popilliae, Pasteuria spp., P. nishizawae, P. penetrans, P. ramosa, P. thornea, P. usgae, Pseudomonas fluorescens, Spodoptera littoralis nucleopolyhedrovirus, Steinernema carpocapsae, S. feltiae, S. kraussei, Streptomyces galbus, S. microflavus;
L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl buty-rate, isopropyl myristate, lavandulol senecioate, cis-jasmone, 2-methyl 1 butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, (R)-1-octen-3-ol, pentatermanone, (E,Z,Z) 3,8,11-tetradecatrienyl acetate, (Z,E) 9,12-tetradecadien-1-yl acetate, (Z) 7 tetradecen-2-one, (Z)-9-tetradecen-1-yl acetate, (Z)-11-tetradecenal, (Z)-11-tetra-decen-1-ol, extract of Chenopodium ambrosioides, Neem oil, Quillay extract;
L5) Microbial pesticides with plant stress reducing, plant growth regulator, plant growth promoting and/or yield enhancing activity: Azospirillum amazonense, A. brasilense, A. lipoferum, A. irakense, A. halopraeferens, Bradyrhizobium spp., B. elkanii, B. japonicum, B. liaoningense, B. lupini, Delftia acidovorans, Glomus intraradices, Mesorhizobium spp., Rhizobium leguminosarum bv. phaseoli, R. I. bv. trifolii, R. I. bv. viciae, R. tropici, Sinorhizobium meliloti;
O) Insecticides from classes O.1 to 0.29
O.1 Acetylcholine esterase (AChE) inhibitors: aldicarb, alanycarb, bendiocarb, benfuracarb, 40) butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, triazamate; acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, pro-thiofos, pyraclofos, pyridaphenthion, quinalphos, sulfotep, tebupirimfos, temephos, terbufos, tetrachlorvinphos, thiometon, triazophos, trichlorfon, vamidothion;
O.2 GABA-gated chloride channel antagonists: endosulfan, chlordane; ethiprole, fipronil, flufiprole, pyrafluprole, pyriprole;
O.3 Sodium channel modulators: acrinathrin, allethrin, d-cis-trans allethrin, d-trans allethrin, bifenthrin, kappa-bifenthrin, bioallethrin, bioallethrin S-cyclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, heptafluthrin, imiprothrin, meperfluthrin, metofluthrin, momfluorothrin, epsilon-momfluorothrin, permethrin, phenothrin, prallethrin, profluthrin, pyrethrin (pyrethrum), resmethrin, silafluofen, tefluthrin, kappa-tefluthrin, tetramethylfluthrin, tetramethrin, tralomethrin, transfluthrin; DDT, methoxychlor;
O.4 Nicotinic acetylcholine receptor (nAChR) agonists: acetamiprid, clothianidin, cycloxaprid, dinotefuran, imidacloprid, nitenpyram, thiacloprid, thiamethoxam; nicotine; sulfoxaflor, flupyradifurone, triflumezopyrim, fenmezoditiaz, flupyrimin;
O.5 Nicotinic acetylcholine receptor allosteric activators: spinosad, spinetoram;
O.6 Chloride channel activators: abamectin, emamectin benzoate, ivermectin, lepimectin, milbemectin;
O.7 Juvenile hormone mimics: hydroprene, kinoprene, methoprene; fenoxycarb, pyriproxyfen;
O.8 miscellaneous non-specific (multi-site) inhibitors: methyl bromide and other alkyl halides; chloropicrin, sulfuryl fluoride, borax, tartar emetic;
O.9 Chordotonal organ TRPV channel modulators: afidopyropen, pymetrozine, pyrifluquinazon;
O.10 Mite growth inhibitors: clofentezine, hexythiazox, diflovidazin; etoxazole;
O.11 Microbial disruptors of insect midgut membranes: Bacillus thuringiensis, B. sphaericus and the insecticidal proteins they produce: Bacillus thuringiensis subsp. israelensis, B. sphaericus, B. thuringiensis subsp. aizawai, B. thuringiensis subsp. kurstaki, B. thuringiensis subsp. tenebrionis, the Bt crop proteins: Cry1Ab, Cry1Ac, Cry1Fa, Cry2Ab, mCry3A, Cry3Ab, Cry3Bb, Cry34/35Ab1;
O.12 Inhibitors of mitochondrial ATP synthase: diafenthiuron; azocyclotin, cyhexatin, fenbutatin oxide, propargite, tetradifon;
O.13 Uncouplers of oxidative phosphorylation via disruption of the proton gradient: chlorfenapyr, DNOC, sulfluramid;
O.14 Nicotinic acetylcholine receptor (nAChR) channel blockers: bensultap, cartap hydrochloride, thiocyclam, thiosultap sodium;
O.15 Inhibitors of the chitin biosynthesis type 0: bistrifluron, chlorfluazuron, diflubenzuron, flucycloxuron, flufenoxuron, hexaflumuron, lufenuron, novaluron, noviflumuron, teflubenzuron, triflumuron;
O.16 Inhibitors of the chitin biosynthesis type 1: buprofezin;
O.17 Moulting disruptors: cyromazine;
O.18 Ecdyson receptor agonists: methoxyfenozide, tebufenozide, halofenozide, fufenozide, chromafenozide;
O.19 Octopamin receptor agonists: amitraz;
O.20 Mitochondrial complex III electron transport inhibitors: hydramethylnon, acequinocyl, fluacrypyrim, bifenazate;
O.21 Mitochondrial complex I electron transport inhibitors: fenazaquin, fenpyroximate, pyrimidifen, pyridaben, tebufenpyrad, tolfenpyrad; rotenone;
O.22 Voltage-dependent sodium channel blockers: indoxacarb, metaflumizone;
O.23 Inhibitors of the of acetyl CoA carboxylase: spirodiclofen, spiromesifen, spirotetramat, spiropidion, spirobudifen, spidoxamat;
O.24 Mitochondrial complex IV electron transport inhibitors: aluminium phosphide, calcium phosphide, phosphine, zinc phosphide, cyanide;
O.25 Mitochondrial complex II electron transport inhibitors: cyenopyrafen, cyflumetofen, cyetpyrafen, pyflubumide;
O.28 Ryanodine receptor-modulators: chlorantraniliprole, cyantraniliprole, cyclaniliprole, flubendiamide, fluchlodiniliprole; tetrachlorantraniliprole; tetraniliprole; tiorantraniliprole; cyhalodiamide;
O.29 Chordotonal organ modulators: flonicamid;
O.30 GABA-gated chloride channel allosteric modulators: broflanilide, fluxametamide, isocycloseram;
O.33 Calcium-activated potassium channel modulators: acynonapyr;
O.34 Mitochondrial complex III electron transport inhibitors at Qi site: flometoquin;
O.UN Insecticidal compounds of unknown or uncertain mode of action: afoxolaner, azadirachtin, amidoflumet, benzoximate, bromopropylate, chinomethionat, cryolite, cyproflanilide, dicloromezotiaz, dicofol, dimpropyridaz, flufenerim, flometoquin, flu-ensulfone, fluhexafon, fluopyram, fluralaner, metaldehyde, metoxadiazone, piperonyl but-oxide, pyridalyl, tioxazafen, trifluenfuronate, umifoxolaner, actives on basis of Bacillus firmus (Votivo); fluazaindolizine; tyclopyrazoflor; sarolaner, lotilaner; benzpyrimoxan; tigolaner; oxazosulfyl; cyproflanilide, nicofluprole; indazapyroxamet; flupentiofenox; cyclobutrifluram.
P) Herbicides from the Classes P1 to P15
P1) Lipid Biosynthesis Inhibitors:
   ACC-herbicides: alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim;
   non ACC herbicides: benfuresate, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate and vernolate;
P2) ALS Inhibitors:
   sulfonylureas: amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, iofensulfuron, iofensulfuron-sodium, mesosulfuron, metazosulfuron, metsulfuron, metsulfuron-methyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl and tritosulfuron;
   imidazolinones: imazamethabenz, imazamethabenz-methyl, imazamox, imazapic, imazapyr, imazaquin and imazethapyr;
   triazolopyrimidine herbicides and sulfonanilides: cloransulam, cloransulam-methyl, diclosulam, flumetsulam, florasulam, metosulam, penoxsulam, pyrimisulfan and pyroxsulam;
   pyrimidinylbenzoates: bispyribac, bispyribac-sodium, pyribenzoxim, pyriftalid, pyriminobac, pyriminobac-methyl, pyrithiobac, pyrithiobac-sodium;
   sulfonylaminocarbonyl-triazolinone herbicides: flucarbazone, flucarbazone-sodium, propoxycarbazone, propoxycarbazone-sodium, thiencarbazone and thiencarbazone-methyl; and triafamone;
P3) Photosynthesis Inhibitors:
amicarbazone, inhibitors of the photosystem II, triazine herbicides, including of chlorotriazine, triazinones, triazindiones, methylthiotriazines and pyridazinones such as ametryn, atrazine, chloridazon, cyanazine, desmetryn, dimethametryn, hexazinone, metribuzin, prometon, prometryn, propazine, simazine, simetryn, terbumeton, terbuthylazine, terbutryn and trietazine, aryl urea such as chlorbromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thiadiazuron, phenyl carbamates such as desmedipham, karbutilate, phenmedipham, phenmedipham-ethyl, nitrile herbicides such as bromofenoxim, bromoxynil and its salts and esters, ioxynil and its salts and esters, uracils such as bromacil, lenacil and terbacil, and bentazon and bentazon-sodium, pyridate, pyridafol, pentanochlor and propanil and inhibitors of the photosystem I such as diquat, diquat-dibromide, paraquat, paraquat-dichloride and paraquat-dimetilsulfate;
P4) Protoporphyrinogen-IX Oxidase Inhibitors:
acifluorfen, acifluorfen-sodium, azafenidin, bencarbazone, benzfendizone, bifenox, butafenacil, carfentrazone, carfentrazone-ethyl, chlomethoxyfen, chlorphthalim, cinidon-ethyl, cyclopyranil, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, tiafenacil, trifludimoxazin, epyrifenacil;
P5) Bleacher Herbicides:
PDS inhibitors: beflubutamid, diflufenican, fluridone, flurochloridone, flurtamone, norflurazon, picolinafen, rimisoxafen;
HPPD inhibitors: benzobicyclon, benzofenap, bicyclopyrone, clomazone, fenquinotrione, isoxaflutole, mesotrione, oxotrione, pyrasulfotole, pyrazolynate, pyrazoxyfen, sulcotrione, tefuryltrione, tembotrione, tolpyralate, topramezone, bipyrazine, fenpyrazone, cypyrafluone, tripyrasulfone, benquitrione, dioxopyritrione;
bleacher, unknown target: aclonifen, amitrole fluometuron, bixlozone;
P6) EPSP Synthase Inhibitors:
glyphosate, glyphosate-isopropylammonium, glyphosate-potassium and glyphosate-trimesium (sulfosate);
P7) glutamine synthase inhibitors: bialaphos (bialaphos), bialaphos-sodium, glufosinate, glufosinate-P and glufosinate-ammonium;
P8) DHP synthase inhibitors: asulam;
P9) mitosis inhibitors:
   group K1: dinitroanilines: benfluralin, butralin, dinitramine, ethalfluralin, fluchloralin, oryzalin, pendimethalin, prodiamine and trifluralin; phosphoramidates: amiprophos, amiprophos-methyl, and butamiphos; benzoic acid herbicides: chlorthal, chlorthal-dimethyl; pyridines: dithiopyr and thiazopyr; benzamides: propyzamide and tebutam;
   group K2: carbetamide, chlorpropham, flamprop, flamprop-isopropyl, flamprop-methyl, flamprop-M-isopropyl, flamprop-M-methyl and propham;
P10) VLCFA inhibitors:
   chloroacetamides: acetochlor, alachlor, amidochlor, butachlor, dimethachlor, dimethenamid, dimethenamid-P, metazachlor, metolachlor, metolachlor-S, pethoxamid, pretilachlor, propachlor, propisochlor and thenylchlor,
   oxyacetanilides: flufenacet and mefenacet;
   acetanilides: diphenamid, naproanilide, napropamide and napropamide-M;
   tetrazolinones: fentrazamide;
   other herbicides: anilofos, cafenstrole, fenoxasulfone, ipfencarbazone, piperophos, pyroxasulfone, dimesulfazet and isoxazoline;
P11) cellulose biosynthesis inhibitors: chlorthiamid, dichlobenil, flupoxam, indaziflam, isoxaben, triaziflam;
P12) decoupler herbicides: dinoseb, dinoterb and DNOC and its salts;
P13) auxinic herbicides:
2,4-D and its salts and esters such as clacyfos, 2,4-DB and its salts and esters, aminocyclopyrachlor and its salts and esters, aminopyralid and its salts such as aminopyralid-dimethylammonium, aminopyralid-tris(2-hydroxypropyl) ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, florpyrauxifen, fluroxypyr, fluroxypyr-butometyl, fluroxypyr-meptyl, halauxifen and its salts and esters; MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters, triclopyr and its salts and esters, florpyrauxifen, florpyrauxifen-benzyl and 4-amino-3-chloro-5-fluoro-6-(7-fluoro-1H-indol-6-yl) picolinic acid;
P14) auxin transport inhibitors: diflufenzopyr, diflufenzopyr-sodium, naptalam and naptalam-sodium;
P15) other herbicides: bromobutide, chlorflurenol, chlorflurenol-methyl, cinmethylin, cumyluron, cyclopyrimorate and its salts and esters, dalapon, dazomet, difenzoquat, difenzoquat-metilsulfate, dimethipin, DSMA, dymron, endothal and its salts, etobenzanid, flurenol, flurenol-butyl, flurprimidol, fosamine, fosamine-ammonium, indanofan, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine, tetflupyrolimet, tridiphane.
Q) Safeners
(quinolin-8-oxy) acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally acceptable salts and their agriculturally acceptable derivatives such amides, esters, and thioesters, provided they have an acid group.

Each of the one or more pesticides may be any substance, whether a chemical or biological agent, used to control pests, such as insecticides, herbicides, fungicides, acaricides, rodenticides, nematicides, and miticides.

Suitable insecticides may preferably be selected from the group consisting of neonicotinoids, bisamides, benzoylureas and carbamates.

It is especially preferred that each insecticide is selected from fenoxycarb, deltamethrin, piperonyl butoxide, imidacloprid, thiacloprid, acetamiprid, aldicarb, aldicarb sulfoxide, aldicarb sulfone, pirimicarb, chlorantraniliprole, terbufos, quinalphos, dyfonate, phosmet, carbaryl, etoxazole, thiamethoxam, flonicamid, etofenprox, phorate, profenofos, parathion, methylparathion, acephate, disulfoton, fenthion, fenvalerate, fipronil, baygon, methomyl, metaflumizone, pymetrozine, oxamyl, tau-fluvalinate, cypermethrin, cyfluthrin, bifenthrin, tetramethrin, prallethrin (mix of isomers), permethrin (mix of isomers), resmethrin (mix of isomers), pyrethrin (mix of isomers), spinetoram (J), abamectin (mix of isomers), fenobucarb (BPMC), methiocarb, isoprocarb (MIPC), spirotetramat, Spinosad, trichlorfon, fenamiphos sulfoxide, fenamiphos sulfone, 3-hydroxycarbofuran, aldrin, DDE (p-p′), DDD (o-p), DDD (p-p′), DDE (o-p), DDT (o-p′), dieldrin, endrin, endrin aldehyde, endrin ketone, isodrin, chlordecone, or mirex (Dodecachlorooctahydro-1H-1,3,4-(epimethanetriyl)cyclobuta [cd]pentalene)

Suitable herbicides may preferably be selected from the group consisting of triazines and other photosystem 2 inhibitors, 2,6-dinitroanilines, ACCase inhibitors, PPO inhibitors, synthetic auxins, sulfonyl ureas, bipyrillium herbicides, chloroacetanilides, triazolopyrimidines, pyrazoles and herbicidal safeners.

It is especially preferred that each herbicide is selected from paclobutrazol, diuron, linuron, isoproturon, alachlor, pendimethalin, chlorpropham, fenoprop, bentazone, metolachlor, propazine, bromacil, 2,4-DB, fenoxaprop, fluometuron, pinoxaden, molinate, cyanazine, simazine, atrazine, atrazine desmethyl, or metribuzin.

Suitable fungicides may preferably be selected from the group consisting of pyrimidines, anilinopyrimidines, triazoles and other sterol demethylation inhibitors, triazolopyrimidines, MAP kinase inhibitors, strobilurins, adenosine deaminase inhibitors, pyrazoles and carboxamides.

It is especially preferred that each fungicide is selected from bitertanol, boscalid, bromuconazole, cyproconazole, diclobutrazol, diniconazole, epoxiconazole, etaconazole, fenbuconazole, fluquinconazole, flusilazole, flutriafol, hexaconazole, myclobutanil, penconazole, propiconazole, prothioconazole, tebuconazole, tetraconazole, triadimefon, triadimenol, triticonazole,2-aminobutane, 8-hydroxyquinoline sulphate, 2-phenylphenol (OPP), aldi-morph, ampropylfos, anilazine, azoxystrobin, benalaxyl, benodanil, benomyl, binapacryl, biphenyl, blasticidin-S, bupirimate, buthiobate, calcium polysulphide, captafol, captan, carbendazim, carboxin, carpropamid, quinomethionate, chloroneb, chloropicrin, chlorothalonil, chlozolinate, cufraneb, cyazofamid, cymoxanil, cyprodinil, cyprofuram, dichlorophen, diclocymet, dichlofluanid, diclomezine, dicloran, diethofencarb, diflumetorim, dimethirimol, dimethomorph, dinocap, diphenylamine, dipyrithione, ditalimfos, dithianon, dodine, drazoxolon, edifenphos, enestroburin, ethaboxam, ethirimol, etridiazole, famoxadone, fenamidone, fenarimol, fenfuram, fenhexamid, fenitropan, fenpiclonil, fenpropidin, fenpropimorph, fentin acetate, fentin hydroxide, ferbam, ferimzone, fluazinam, fludioxonil, flumorph, fluoromide, fluoxastrobin, flusulfamide, flutolanil, folpet, fosetyl-aluminium, fthalide, fuberidazole, furalaxyl, furmecyclox, guazatine, hexachlorobenzene, imazalil, iminoctadine, iprobenfos (IBP), iprodione, iprovalicarb, isoprothiolane, kasugamycin, copper preparations such as: copper hydroxide, copper naphthenate, copper oxychloride, copper sulphate, copper oxide, oxine-copper and Bordeaux mixture, mancopper, mancozeb, maneb, mepanipyrim, kresoxim-methyl, mepronil, metalaxyl, methasulfocarb, methfuroxam, metiram, metominostrobin, metrafenone, metsulfovax, myclobutanil, nickel dimethyldithiocarbamate, nitrothal-isopropyl, nuarimol, ofurace, oxadixyl, oxamocarb, oxycarboxin, pefurazoate, pencycuron, phosdiphen, picoxystrobin, pimaricin, piperalin, polyoxin, probenazole, prochloraz, procymidone, propamocarb, propineb, pyraclostrobin, pyrazophos, pyrifenox, pyrimethanil, pyroquilon, quinoxyfen, quintozene (PCNB), silthiofam, spiroxamine, sulphur and sulphur preparations, tecloftalam, tecnazene, thiabendazole, thicyofen, thifluzamide, thiophanate-methyl, thiram, tolclophos-methyl, tolylfluanid, triazoxide, trichlamide, tricyclazole, tridemorph, trifloxystrobin, triflumizole, triforine, validamycin, vinclozolin, zineb, ziram, or zoxamide.

Suitable acaricides may preferably be selected from tebufenpyrad, aldicarb, azinphosmethyl, carbophenothion, dimethoate, dicrotophos, triazophos, malathion, phosalone, methidathion, hexythiazox, propargite, spirodiclofen, methamidophos, monocrotophos, phenthoate, pirimiphosmethyl, epn, dichlorvos, ethion, fenitrothion, diazinon, chlorpyriphos, oxydemeton methyl, pyridaben, fenpropathrin, bifenazate, spiromesifen, fenpyroximate (mix of isomers), acequinocyl, or carbofuran.

One suitable rodenticide is coumaphos.

One suitable nematicide is ethoprophos.

One suitable miticide is clofentezine.

In the context of agrochemical emulsifiable concentrates, the one or more pesticides are preferably selected from the group consisting of insecticides, herbicides, fungicides and combinations thereof, wherein the examples of each class of pesticide may be as defined above and below.

It is particularly preferred that least one of the one or more pesticides is selected from the group consisting of azoxystrobin, prothioconazole, pyraclostrobin, oxyfluorfen, difenoconazole, trifloxystrobin, propiconazole, cyproconazole, flufenacetate, epoxiconazole, fluxapyroxad, fenbuconazole, tebuconazole, metaflumizone, pinoxaden, deltamethrin and pendimethalin.

It is a finding of the present invention that the solubility of each of these commercially important pesticides is generally improved in the solvent according to the present invention, when compared with typical solvent systems used for agrochemical emulsifiable concentrates, such as fatty acid methyl esters and fatty acid dimethylamides.

It is thus preferred that the total pesticide content in the emulsifiable concentrate (EC) is in the range from 5 to 70% w/w, more preferably in the range from 10 to 65% w/w, most preferably in the range from 15 to 60% w/w, relative to the total weight of the emulsifiable concentrate (EC).

In the context of agrochemical emulsifiable concentrates, it is also well known that more than one pesticide may be used, resulting in a so-called combination formulation. Such combination formulations may have improved effects since the individual pesticides act in a synergistic manner or alternatively, the multiple pesticides may be active against different pests, for example, one pesticide may be a herbicide and another may be an insecticide.

In one embodiment, the emulsifiable concentrate (EC) comprises two or more pesticides.

Many such combination formulations are commercially available and are well known in the field. As such, the choice of which combination of pesticides is selected is not particularly limited.

In a preferred embodiment, at least one, more preferably at least two, of the two or more pesticides is/are selected from the group consisting of azoxystrobin, prothioconazole, pyraclostrobin, oxyfluorfen, difenoconazole, trifloxystrobin, propiconazole, cyproconazole, flufenacetate, epoxiconazole, fluxapyroxad, fenbuconazole, tebuconazole, metaflumizone, pinoxaden, deltamethrin and pendimethalin.

### The One or More Emulsifiers

Another essential component of the emulsifiable concentrate (EC) is one or more emulsifiers.

The one or more emulsifiers of the present invention are not particularly limited. In its broadest form, the one or more emulsifiers may be selected from any conventional emulsifiers typically used in the field of agrochemical compositions and formulations.

For Example, the One or More Emulsifiers May be Selected from:
products of the addition of 2 to 30 mol ethylene oxide and/or 0 to 5 mol propylene oxide onto linear C8-22 fatty alcohols, onto C12-22 fatty acids and onto alkyl phenols containing 8 to 15 carbon atoms in the alkyl group;
C12-18 fatty acid monoesters and diesters of addition products of 1 to 30 mol ethylene oxide onto glycerol; 20)
glycerol mono- and diesters and sorbitan mono- and diesters of saturated and unsaturated fatty acids containing 6 to 22 carbon atoms and ethylene oxide addition products thereof
addition products of 15 to 60 mol ethylene oxide onto castor oil and/or hydrogenated castor oil;
polyol esters and, in particular, polyglycerol esters such as, for example, polyglycerol polyricinoleate, polyglycerol poly-12-hydroxystearate or polyglycerol dimerate isostearate;
addition products of 2 to 15 mol ethylene oxide onto castor oil and/or hydrogenated castor oil;
partial esters based on linear, branched, unsaturated or saturated C6-22 fatty acids, ricinoleic acid and 12-hydroxystearic acid and glycerol, polyglycerol, pentaerythritol,-dipentaerythritol, sugar alcohols (for example sorbitol), alkyl glucosides (for example methyl glucoside, butyl glucoside, lauryl glucoside) and polyglucosides (for example cellulose); 30
mono-, di and trialkyl phosphates and mono-, di- and/or tri-PEG-alkyl phosphates and salts thereof;
wool wax alcohols;
polysiloxane/polyalkyl polyether copolymers and corresponding derivatives;
mixed esters of pentaerythritol, fatty acids, citric acid and fatty alcohol and/or mixed esters of C6-22 fatty acids, methyl glucose and polyols, preferably glycerol or polyglycerol, and
polyalkylene glycols

The one or more emulsifiers are preferably selected from the group consisting of non-ionic emulsifiers, anionic emulsifiers and combinations thereof.

It is particularly preferred that at least one of the one or more emulsifiers is a non-ionic emulsifier.

It is also preferred that at least one of the one or more emulsifiers is an anionic emulsifier.

In one particularly preferred embodiment, the one or more emulsifiers comprises, more preferably consists of, a non-ionic emulsifier and an anionic emulsifier.

Suitable non-ionic emulsifiers may be selected from the group consisting of copolymers containing ethylene oxide and propylene oxide monomers, alcohol alkoxylates, alkyl polyglucosides, aminopolyols, polyalkylene glycols, alkoxylated animal or vegetable fats and oils such as corn oil ethoxylates, soybean oil ethoxylates, castor oil ethoxylates, tallow fatty ethoxylates, glycerol esters such as glycerol monostearate, fatty alcohol alkoxylates and oxoalcohol alkoxylates, fatty acid alkoxylates such as oleic acid ethoxylates, alkylphenol alkoxylates such as isononylphenol ethoxylates, fatty amine alkoxylates, fatty acid amide alkoxylates, sugar surfactants such as sorbitan fatty acid esters (e.g. sorbitan monooleate, and sorbitan tristearate), polyoxyethylene sorbitan fatty acid esters, alkyl polyglycosides, N-alkylglucamines, alkylmethyl sulfoxides, alkyldimethylphosphine oxides such as tetradecyldimethylphosphine oxide, or combinations thereof.

It is preferred that at least one of the one or more emulsifiers is a castor oil ethoxylate.

Suitable anionic emulsifiers include salts wherein the anion may be selected from the group consisting of fatty acids, fatty alcohol ether sulfates, fatty alcohol sulfates, alkylbenzene sulfonates, ether phosphates, alkyl sulfates, alkyl ether sulfates, alkylsulfonates or iso-alkylsulfonates, alkylnaphthalenesulfonates, alkyl methyl ester sulfonates, acyl glutamates, alkylsulfosuccinates, sarcosinates, taurates and combinations thereof, whilst the cation may be selected from the group selected from alkali metal ions, alkaline earth metal ions, ammonium ions and combinations thereof.

It is preferred that at least one of the one or more emulsifiers is an alkyl benzene sulfonate, more preferably a linear alkylbenzene sulfonate.

In one especially preferred embodiment, the one or more emulsifiers comprises, more preferably consists of, a castor oil ethoxylate and an alkylbenzene sulfonate. In this especially preferred embodiment, the alkyl benzene sulfonate is more preferably a linear alkylbenzene sulfonate.

The total content of the one or more emulsifiers in the emulsifiable concentrate (EC) is preferably in the range from 1 to 30% w/w, more preferably in the range from 5 to 20% w/w, most preferably in the range from 10 to 15% w/w, relative to the total weight of the emulsifiable concentrate (EC).

### The Emulsifiable Concentrate (EC)

As detailed above, the emulsifiable concentrate (EC) according to the present invention comprises one or more pesticides, one or more emulsifiers and the solvent as described above.

Particularly preferred combinations of one or more pesticides, one or more emulsifiers and one or more solvents are given in Table A:

| # | Pesticide(s) | Solvent(s) | Emulsifier(s) |
|---|---|---|---|
| 1 | P1 | S1 | E1 |
| 2 | P1 | S1 | E2 |
| 3 | P1 | S1 | E3 |
| 4 | P1 | S1 | E4 |
| 5 | P1 | S1 | E2 + E3 |
| 6 | P1 | S1 | E2 + E4 |
| 7 | P1 | S1 | E3 + E4 |
| 8 | P1 | S1 | E2 + E3 + E4 |
| 9 | P1 | S2 | E1 |
| 10 | P1 | S2 | E2 |
| 11 | P1 | S2 | E3 |
| 12 | P1 | S2 | E4 |
| 13 | P1 | S2 | E2 + E3 |
| 14 | P1 | S2 | E2 + E4 |
| 15 | P1 | S2 | E3 + E4 |
| 16 | P1 | S2 | E2 + E3 + E4 |
| 17 | P1 | S3 | E1 |
| 18 | P1 | S3 | E2 |
| 19 | P1 | S3 | E3 |
| 20 | P1 | S3 | E4 |
| 21 | P1 | S3 | E2 + E3 |
| 22 | P1 | S3 | E2 + E4 |
| 23 | P1 | S3 | E3 + E4 |
| 24 | P1 | S3 | E2 + E3 + E4 |
| 25 | P1 | S4 | E1 |
| 26 | P1 | S4 | E2 |
| 27 | P1 | S4 | E3 |
| 28 | P1 | S4 | E4 |
| 29 | P1 | S4 | E2 + E3 |
| 30 | P1 | S4 | E2 + E4 |
| 31 | P1 | S4 | E3 + E4 |
| 32 | P1 | S4 | E2 + E3 + E4 |
| 33 | P1 | S5 | E1 |
| 34 | P1 | S5 | E2 |
| 35 | P1 | S5 | E3 |
| 36 | P1 | S5 | E4 |
| 37 | P1 | S5 | E2 + E3 |
| 38 | P1 | S5 | E2 + E4 |
| 39 | P1 | S5 | E3 + E4 |
| 40 | P1 | S5 | E2 + E3 + E4 |
| 41 | P1 | S6 | E1 |
| 42 | P1 | S6 | E2 |
| 43 | P1 | S6 | E3 |
| 44 | P1 | S6 | E4 |
| 45 | P1 | S6 | E2 + E3 |
| 46 | P1 | S6 | E2 + E4 |
| 47 | P1 | S6 | E3 + E4 |
| 48 | P1 | S6 | E2 + E3 + E4 |
| 49 | P1 | S7 | E1 |
| 50 | P1 | S7 | E2 |
| 51 | P1 | S7 | E3 |
| 52 | P1 | S7 | E4 |
| 53 | P1 | S7 | E2 + E3 |
| 54 | P1 | S7 | E2 + E4 |
| 55 | P1 | S7 | E3 + E4 |
| 56 | P1 | S7 | E2 + E3 + E4 |
| 57 | P1 | S8 | E1 |
| 58 | P1 | S8 | E2 |
| 59 | P1 | S8 | E3 |
| 60 | P1 | S8 | E4 |
| 61 | P1 | S8 | E2 + E3 |
| 62 | P1 | S8 | E2 + E4 |
| 63 | P1 | S8 | E3 + E4 |
| 64 | P1 | S8 | E2 + E3 + E4 |
| 65 | P2 | S1 | E1 |
| 65 | P1 | S9 | E1 |
| 66 | P1 | S9 | E2 |
| 67 | P1 | S9 | E3 |
| 68 | P1 | S9 | E4 |
| 69 | P1 | S9 | E2 + E3 |
| 70 | P1 | S9 | E2 + E4 |
| 71 | P1 | S9 | E3 + E4 |
| 72 | P1 | S9 | E2 + E3 + E4 |
| 73 | P2 | S1 | E1 |
| 74 | P2 | S1 | E2 |
| 75 | P2 | S1 | E3 |
| 76 | P2 | S1 | E4 |
| 77 | P2 | S1 | E2 + E3 |
| 78 | P2 | S1 | E2 + E4 |
| 79 | P2 | S1 | E3 + E4 |
| 80 | P2 | S1 | E2 + E3 + E4 |
| 81 | P2 | S2 | E1 |
| 83 | P2 | S2 | E3 |
| 84 | P2 | S2 | E4 |
| 85 | P2 | S2 | E2 + E3 |
| 86 | P2 | S2 | E2 + E4 |
| 87 | P2 | S2 | E3 + E4 |
| 88 | P2 | S2 | E2 + E3 + E4 |
| 89 | P2 | S3 | E1 |
| 90 | P2 | S3 | E2 |
| 91 | P2 | S3 | E3 |
| 92 | P2 | S3 | E4 |
| 93 | P2 | S3 | E2 + E3 |
| 94 | P2 | S3 | E2 + E4 |
| 95 | P2 | S3 | E3 + E4 |
| 96 | P2 | S3 | E2 + E3 + E4 |
| 97 | P2 | S4 | E1 |
| 98 | P2 | S4 | E2 |
| 99 | P2 | S4 | E3 |
| 100 | P2 | S4 | E4 |
| 101 | P2 | S4 | E2 + E3 |
| 102 | P2 | S4 | E2 + E4 |
| 103 | P2 | S4 | E3 + E4 |
| 104 | P2 | S4 | E2 + E3 + E4 |
| 105 | P2 | S5 | E1 |
| 106 | P2 | S5 | E2 |
| 107 | P2 | S5 | E3 |
| 108 | P2 | S5 | E4 |
| 109 | P2 | S5 | E2 + E3 |
| 110 | P2 | S5 | E2 + E4 |
| 111 | P2 | S5 | E3 + E4 |
| 112 | P2 | S5 | E2 + E3 + E4 |
| 113 | P2 | S6 | E1 |
| 114 | P2 | S6 | E2 |
| 115 | P2 | S6 | E3 |
| 116 | P2 | S6 | E4 |
| 117 | P2 | S6 | E2 + E3 |
| 118 | P2 | S6 | E2 + E4 |
| 119 | P2 | S6 | E3 + E4 |
| 120 | P2 | S6 | E2 + E3 + E4 |
| 121 | P2 | S7 | E1 |
| 122 | P2 | S7 | E2 |
| 123 | P2 | S7 | E3 |
| 124 | P2 | S7 | E4 |
| 125 | P2 | S7 | E2 + E3 |
| 126 | P2 | S7 | E2 + E4 |
| 127 | P2 | S7 | E3 + E4 |
| 128 | P2 | S7 | E2 + E3 + E4 |
| 129 | P2 | S8 | E1 |
| 130 | P2 | S8 | E2 |
| 131 | P2 | S8 | E3 |
| 132 | P2 | S8 | E4 |
| 133 | P2 | S8 | E2 + E3 |
| 134 | P2 | S8 | E2 + E4 |
| 135 | P2 | S8 | E3 + E4 |
| 136 | P2 | S8 | E2 + E3 + E4 |
| 137 | P2 | S9 | E1 |
| 138 | P2 | S9 | E2 |
| 139 | P2 | S9 | E3 |
| 140 | P2 | S9 | E4 |
| 141 | P2 | S9 | E2 + E3 |
| 142 | P2 | S9 | E2 + E4 |
| 143 | P2 | S9 | E3 + E4 |
| 144 | P2 | S9 | E2 + E3 + E4 |
| 145 | P3 | S1 | E1 |
| 146 | P3 | S1 | E2 |
| 147 | P3 | S1 | E3 |
| 148 | P3 | S1 | E4 |
| 149 | P3 | S1 | E2 + E3 |
| 150 | P3 | S1 | E2 + E4 |
| 151 | P3 | S1 | E3 + E4 |
| 152 | P3 | S1 | E2 + E3 + E4 |
| 153 | P3 | S2 | E1 |
| 154 | P3 | S2 | E2 |
| 155 | P3 | S2 | E3 |
| 156 | P3 | S2 | E4 |
| 157 | P3 | S2 | E2 + E3 |
| 158 | P3 | S2 | E2 + E4 |
| 159 | P3 | S2 | E3 + E4 |
| 160 | P3 | S2 | E2 + E3 + E4 |
| 161 | P3 | S3 | E1 |
| 162 | P3 | S3 | E2 |
| 163 | P3 | S3 | E3 |
| 164 | P3 | S3 | E4 |
| 165 | P3 | S3 | E2 + E3 |
| 166 | P3 | S3 | E2 + E4 |
| 167 | P3 | S3 | E3 + E4 |
| 168 | P3 | S3 | E2 + E3 + E4 |
| 169 | P3 | S4 | E1 |
| 170 | P3 | S4 | E2 |
| 171 | P3 | S4 | E3 |
| 172 | P3 | S4 | E4 |
| 173 | P3 | S4 | E2 + E3 |
| 174 | P3 | S4 | E2 + E4 |
| 175 | P3 | S4 | E3 + E4 |
| 176 | P3 | S4 | E2 + E3 + E4 |
| 177 | P3 | S5 | E1 |
| 178 | P3 | S5 | E2 |
| 179 | P3 | S5 | E3 |
| 180 | P3 | S5 | E4 |
| 181 | P3 | S5 | E2 + E3 |
| 182 | P3 | S5 | E2 + E4 |
| 183 | P3 | S5 | E3 + E4 |
| 184 | P3 | S5 | E2 + E3 + E4 |
| 185 | P3 | S6 | E1 |
| 186 | P3 | S6 | E2 |
| 187 | P3 | S6 | E3 |
| 188 | P3 | S6 | E4 |
| 189 | P3 | S6 | E2 + E3 |
| 190 | P3 | S6 | E2 + E4 |
| 191 | P3 | S6 | E3 + E4 |
| 192 | P3 | S6 | E2 + E3 + E4 |
| 193 | P3 | S7 | E1 |
| 194 | P3 | S7 | E2 |
| 195 | P3 | S7 | E3 |
| 196 | P3 | S7 | E4 |
| 197 | P3 | S7 | E2 + E3 |
| 198 | P3 | S7 | E2 + E4 |
| 199 | P3 | S7 | E3 + E4 |
| 200 | P3 | S7 | E2 + E3 + E4 |
| 201 | P3 | S8 | E1 |
| 202 | P3 | S8 | E2 |
| 203 | P3 | S8 | E3 |
| 204 | P3 | S8 | E4 |
| 205 | P3 | S8 | E2 + E3 |
| 206 | P3 | S8 | E2 + E4 |
| 207 | P3 | S8 | E3 + E4 |
| 208 | P3 | S8 | E2 + E3 + E4 |
| 209 | P3 | S9 | E1 |
| 210 | P3 | S9 | E2 |
| 211 | P3 | S9 | E3 |
| 212 | P3 | S9 | E4 |
| 213 | P3 | S9 | E2 + E3 |
| 214 | P3 | S9 | E2 + E4 |
| 215 | P3 | S9 | E3 + E4 |
| 216 | P3 | S9 | E2 + E3 + E4 |
| 217 | P4 | S1 | E1 |
| 218 | P4 | S1 | E2 |
| 219 | P4 | S1 | E3 |
| 220 | P4 | S1 | E4 |
| 221 | P4 | S1 | E2 + E3 |
| 222 | P4 | S1 | E2 + E4 |
| 223 | P4 | S1 | E3 + E4 |
| 224 | P4 | S1 | E2 + E3 + E4 |
| 225 | P4 | S2 | E1 |
| 226 | P4 | S2 | E2 |
| 227 | P4 | S2 | E3 |
| 228 | P4 | S2 | E4 |
| 229 | P4 | S2 | E2 + E3 |
| 230 | P4 | S2 | E2 + E4 |
| 231 | P4 | S2 | E3 + E4 |
| 232 | P4 | S2 | E2 + E3 + E4 |
| 233 | P4 | S3 | E1 |
| 234 | P4 | S3 | E2 |
| 235 | P4 | S3 | E3 |
| 236 | P4 | S3 | E4 |
| 237 | P4 | S3 | E2 + E3 |
| 238 | P4 | S3 | E2 + E4 |
| 239 | P4 | S3 | E3 + E4 |
| 240 | P4 | S3 | E2 + E3 + E4 |
| 241 | P4 | S4 | E1 |
| 242 | P4 | S4 | E2 |
| 243 | P4 | S4 | E3 |
| 244 | P4 | S4 | E4 |
| 245 | P4 | S4 | E2 + E3 |
| 246 | P4 | S4 | E2 + E4 |
| 247 | P4 | S4 | E3 + E4 |
| 248 | P4 | S4 | E2 + E3 + E4 |
| 249 | P4 | S5 | E1 |
| 250 | P4 | S5 | E2 |
| 251 | P4 | S5 | E3 |
| 252 | P4 | S5 | E4 |
| 253 | P4 | S5 | E2 + E3 |
| 254 | P4 | S5 | E2 + E4 |
| 255 | P4 | S5 | E3 + E4 |
| 256 | P4 | S5 | E2 + E3 + E4 |
| 257 | P4 | S6 | E1 |
| 258 | P4 | S6 | E2 |
| 259 | P4 | S6 | E3 |
| 260 | P4 | S6 | E4 |
| 261 | P4 | S6 | E2 + E3 |
| 262 | P4 | S6 | E2 + E4 |
| 263 | P4 | S6 | E3 + E4 |
| 264 | P4 | S6 | E2 + E3 + E4 |
| 265 | P4 | S7 | E1 |
| 266 | P4 | S7 | E2 |
| 267 | P4 | S7 | E3 |
| 268 | P4 | S7 | E4 |
| 269 | P4 | S7 | E2 + E3 |
| 270 | P4 | S7 | E2 + E4 |
| 271 | P4 | S7 | E3 + E4 |
| 272 | P4 | S7 | E2 + E3 + E4 |
| 273 | P4 | S8 | E1 |
| 274 | P4 | S8 | E2 |
| 275 | P4 | S8 | E3 |
| 276 | P4 | S8 | E4 |
| 277 | P4 | S8 | E2 + E3 |
| 278 | P4 | S8 | E2 + E4 |
| 279 | P4 | S8 | E3 + E4 |
| 280 | P4 | S8 | E2 + E3 + E4 |
| 281 | P4 | S9 | E1 |
| 282 | P4 | S9 | E2 |
| 283 | P4 | S9 | E3 |
| 284 | P4 | S9 | E4 |
| 285 | P4 | S9 | E2 + E3 |
| 286 | P4 | S9 | E2 + E4 |
| 287 | P4 | S9 | E3 + E4 |
| 288 | P4 | S9 | E2 + E3 + E4 |
| 289 | P5 | S1 | E1 |
| 290 | P5 | S1 | E2 |
| 291 | P5 | S1 | E3 |
| 292 | P5 | S1 | E4 |
| 293 | P5 | S1 | E2 + E3 |
| 294 | P5 | S1 | E2 + E4 |
| 295 | P5 | S1 | E3 + E4 |
| 296 | P5 | S1 | E2 + E3 + E4 |
| 297 | P5 | S2 | E1 |
| 298 | P5 | S2 | E2 |
| 299 | P5 | S2 | E3 |
| 300 | P5 | S2 | E4 |
| 301 | P5 | S2 | E2 + E3 |
| 302 | P5 | S2 | E2 + E4 |
| 303 | P5 | S2 | E3 + E4 |
| 304 | P5 | S2 | E2 + E3 + E4 |
| 305 | P5 | S3 | E1 |
| 306 | P5 | S3 | E2 |
| 307 | P5 | S3 | E3 |
| 308 | P5 | S3 | E4 |
| 309 | P5 | S3 | E2 + E3 |
| 310 | P5 | S3 | E2 + E4 |
| 311 | P5 | S3 | E3 + E4 |
| 312 | P5 | S3 | E2 + E3 + E4 |
| 313 | P5 | S4 | E1 |
| 314 | P5 | S4 | E2 |
| 315 | P5 | S4 | E3 |
| 316 | P5 | S4 | E4 |
| 317 | P5 | S4 | E2 + E3 |
| 318 | P5 | S4 | E2 + E4 |
| 319 | P5 | S4 | E3 + E4 |
| 320 | P5 | S4 | E2 + E3 + E4 |
| 321 | P5 | S5 | E1 |
| 322 | P5 | S5 | E2 |
| 323 | P5 | S5 | E3 |
| 324 | P5 | S5 | E4 |
| 325 | P5 | S5 | E2 + E3 |
| 326 | P5 | S5 | E2 + E4 |
| 327 | P5 | S5 | E3 + E4 |
| 328 | P5 | S5 | E2 + E3 + E4 |
| 329 | P5 | S6 | E1 |
| 330 | P5 | S6 | E2 |
| 331 | P5 | S6 | E3 |
| 332 | P5 | S6 | E4 |
| 333 | P5 | S6 | E2 + E3 |
| 334 | P5 | S6 | E2 + E4 |
| 335 | P5 | S6 | E3 + E4 |
| 336 | P5 | S6 | E2 + E3 + E4 |
| 337 | P5 | S7 | E1 |
| 338 | P5 | S7 | E2 |
| 339 | P5 | S7 | E3 |
| 340 | P5 | S7 | E4 |
| 341 | P5 | S7 | E2 + E3 |
| 342 | P5 | S7 | E2 + E4 |
| 343 | P5 | S7 | E3 + E4 |
| 344 | P5 | S7 | E2 + E3 + E4 |
| 345 | P5 | S8 | E1 |
| 346 | P5 | S8 | E2 |
| 347 | P5 | S8 | E3 |
| 348 | P5 | S8 | E4 |
| 349 | P5 | S8 | E2 + E3 |
| 350 | P5 | S8 | E2 + E4 |
| 351 | P5 | S8 | E3 + E4 |
| 352 | P5 | S8 | E2 + E3 + E4 |
| 353 | P5 | S9 | E1 |
| 354 | P5 | S9 | E2 |
| 355 | P5 | S9 | E3 |
| 356 | P5 | S9 | E4 |
| 357 | P5 | S9 | E2 + E3 |
| 358 | P5 | S9 | E2 + E4 |
| 359 | P5 | S9 | E3 + E4 |
| 360 | P5 | S9 | E2 + E3 + E4 |
| 361 | P6 | S1 | E1 |
| 362 | P6 | S1 | E2 |
| 363 | P6 | S1 | E3 |
| 364 | P6 | S1 | E4 |
| 365 | P6 | S1 | E2 + E3 |
| 366 | P6 | S1 | E2 + E4 |
| 367 | P6 | S1 | E3 + E4 |
| 368 | P6 | S1 | E2 + E3 + E4 |
| 369 | P6 | S2 | E1 |
| 370 | P6 | S2 | E2 |
| 371 | P6 | S2 | E3 |
| 372 | P6 | S2 | E4 |
| 373 | P6 | S2 | E2 + E3 |
| 374 | P6 | S2 | E2 + E4 |
| 375 | P6 | S2 | E3 + E4 |
| 376 | P6 | S2 | E2 + E3 + E4 |
| 377 | P6 | S3 | E1 |
| 378 | P6 | S3 | E2 |
| 379 | P6 | S3 | E3 |
| 380 | P6 | S3 | E4 |
| 381 | P6 | S3 | E2 + E3 |
| 382 | P6 | S3 | E2 + E4 |
| 383 | P6 | S3 | E3 + E4 |
| 384 | P6 | S3 | E2 + E3 + E4 |
| 385 | P6 | S4 | E1 |
| 386 | P6 | S4 | E2 |
| 387 | P6 | S4 | E3 |
| 388 | P6 | S4 | E4 |
| 389 | P6 | S4 | E2 + E3 |
| 390 | P6 | S4 | E2 + E4 |
| 391 | P6 | S4 | E3 + E4 |
| 392 | P6 | S4 | E2 + E3 + E4 |
| 393 | P6 | S5 | E1 |
| 394 | P6 | S5 | E2 |
| 395 | P6 | S5 | E3 |
| 396 | P6 | S5 | E4 |
| 397 | P6 | S5 | E2 + E3 |
| 398 | P6 | S5 | E2 + E4 |
| 399 | P6 | S5 | E3 + E4 |
| 400 | P6 | S5 | E2 + E3 + E4 |
| 401 | P6 | S6 | E1 |
| 402 | P6 | S6 | E2 |
| 403 | P6 | S6 | E3 |
| 404 | P6 | S6 | E4 |
| 405 | P6 | S6 | E2 + E3 |
| 406 | P6 | S6 | E2 + E4 |
| 407 | P6 | S6 | E3 + E4 |
| 408 | P6 | S6 | E2 + E3 + E4 |
| 409 | P6 | S7 | E1 |
| 410 | P6 | S7 | E2 |
| 411 | P6 | S7 | E3 |
| 412 | P6 | S7 | E4 |
| 413 | P6 | S7 | E2 + E3 |
| 414 | P6 | S7 | E2 + E4 |
| 415 | P6 | S7 | E3 + E4 |
| 416 | P6 | S7 | E2 + E3 + E4 |
| 417 | P6 | S8 | E1 |
| 418 | P6 | S8 | E2 |
| 419 | P6 | S8 | E3 |
| 420 | P6 | S8 | E4 |
| 421 | P6 | S8 | E2 + E3 |
| 422 | P6 | S8 | E2 + E4 |
| 423 | P6 | S8 | E3 + E4 |
| 424 | P6 | S8 | E2 + E3 + E4 |
| 425 | P6 | S9 | E1 |
| 426 | P6 | S9 | E2 |
| 427 | P6 | S9 | E3 |
| 428 | P6 | S9 | E4 |
| 429 | P6 | S9 | E2 + E3 |
| 430 | P6 | S9 | E2 + E4 |
| 431 | P6 | S9 | E3 + E4 |
| 432 | P6 | S9 | E2 + E3 + E4 |
| 433 | P7 | S1 | E1 |
| 434 | P7 | S1 | E2 |
| 435 | P7 | S1 | E3 |
| 436 | P7 | S1 | E4 |
| 437 | P7 | S1 | E2 + E3 |
| 438 | P7 | S1 | E2 + E4 |
| 439 | P7 | S1 | E3 + E4 |
| 440 | P7 | S1 | E2 + E3 + E4 |
| 441 | P7 | S2 | E1 |
| 442 | P7 | S2 | E2 |
| 443 | P7 | S2 | E3 |
| 444 | P7 | S2 | E4 |
| 445 | P7 | S2 | E2 + E3 |
| 446 | P7 | S2 | E2 + E4 |
| 447 | P7 | S2 | E3 + E4 |
| 448 | P7 | S2 | E2 + E3 + E4 |
| 449 | P7 | S3 | E1 |
| 450 | P7 | S3 | E2 |
| 451 | P7 | S3 | E3 |
| 452 | P7 | S3 | E4 |
| 453 | P7 | S3 | E2 + E3 |
| 454 | P7 | S3 | E2 + E4 |
| 455 | P7 | S3 | E3 + E4 |
| 456 | P7 | S3 | E2 + E3 + E4 |
| 457 | P7 | S4 | E1 |
| 458 | P7 | S4 | E2 |
| 459 | P7 | S4 | E3 |
| 460 | P7 | S4 | E4 |
| 461 | P7 | S4 | E2 + E3 |
| 462 | P7 | S4 | E2 + E4 |
| 463 | P7 | S4 | E3 + E4 |
| 464 | P7 | S4 | E2 + E3 + E4 |
| 465 | P7 | S5 | E1 |
| 466 | P7 | S5 | E2 |
| 467 | P7 | S5 | E3 |
| 468 | P7 | S5 | E4 |
| 469 | P7 | S5 | E2 + E3 |
| 470 | P7 | S5 | E2 + E4 |
| 471 | P7 | S5 | E3 + E4 |
| 472 | P7 | S5 | E2 + E3 + E4 |
| 473 | P7 | S6 | E1 |
| 474 | P7 | S6 | E2 |
| 475 | P7 | S6 | E3 |
| 476 | P7 | S6 | E4 |
| 477 | P7 | S6 | E2 + E3 |
| 478 | P7 | S6 | E2 + E4 |
| 479 | P7 | S6 | E3 + E4 |
| 480 | P7 | S6 | E2 + E3 + E4 |
| 481 | P7 | S7 | E1 |
| 482 | P7 | S7 | E2 |
| 483 | P7 | S7 | E3 |
| 484 | P7 | S7 | E4 |
| 485 | P7 | S7 | E2 + E3 |
| 486 | P7 | S7 | E2 + E4 |
| 487 | P7 | S7 | E3 + E4 |
| 488 | P7 | S7 | E2 + E3 + E4 |
| 489 | P7 | S8 | E1 |
| 490 | P7 | S8 | E2 |
| 491 | P7 | S8 | E3 |
| 492 | P7 | S8 | E4 |
| 493 | P7 | S8 | E2 + E3 |
| 494 | P7 | S8 | E2 + E4 |
| 495 | P7 | S8 | E3 + E4 |
| 496 | P7 | S8 | E2 + E3 + E4 |
| 497 | P7 | S9 | E1 |
| 498 | P7 | S9 | E2 |
| 499 | P7 | S9 | E3 |
| 500 | P7 | S9 | E4 |
| 501 | P7 | S9 | E2 + E3 |
| 502 | P7 | S9 | E2 + E4 |
| 503 | P7 | S9 | E3 + E4 |
| 504 | P7 | S9 | E2 + E3 + E4 |
| 505 | P8 | S1 | E1 |
| 506 | P8 | S1 | E2 |
| 507 | P8 | S1 | E3 |
| 508 | P8 | S1 | E4 |
| 509 | P8 | S1 | E2 + E3 |
| 510 | P8 | S1 | E2 + E4 |
| 511 | P8 | S1 | E3 + E4 |
| 512 | P8 | S1 | E2 + E3 + E4 |
| 513 | P8 | S2 | E1 |
| 514 | P8 | S2 | E2 |
| 515 | P8 | S2 | E3 |
| 516 | P8 | S2 | E4 |
| 517 | P8 | S2 | E2 + E3 |
| 518 | P8 | S2 | E2 + E4 |
| 519 | P8 | S2 | E3 + E4 |
| 520 | P8 | S2 | E2 + E3 + E4 |
| 521 | P8 | S3 | E1 |
| 522 | P8 | S3 | E2 |
| 523 | P8 | S3 | E3 |
| 524 | P8 | S3 | E4 |
| 525 | P8 | S3 | E2 + E3 |
| 526 | P8 | S3 | E2 + E4 |
| 527 | P8 | S3 | E3 + E4 |
| 528 | P8 | S3 | E2 + E3 + E4 |
| 529 | P8 | S4 | E1 |
| 530 | P8 | S4 | E2 |
| 531 | P8 | S4 | E3 |
| 532 | P8 | S4 | E4 |
| 533 | P8 | S4 | E2 + E3 |
| 534 | P8 | S4 | E2 + E4 |
| 535 | P8 | S4 | E3 + E4 |
| 536 | P8 | S4 | E2 + E3 + E4 |
| 537 | P8 | S5 | E1 |
| 538 | P8 | S5 | E2 |
| 539 | P8 | S5 | E3 |
| 540 | P8 | S5 | E4 |
| 541 | P8 | S5 | E2 + E3 |
| 542 | P8 | S5 | E2 + E4 |
| 543 | P8 | S5 | E3 + E4 |
| 544 | P8 | S5 | E2 + E3 + E4 |
| 545 | P8 | S6 | E1 |
| 546 | P8 | S6 | E2 |
| 547 | P8 | S6 | E3 |
| 548 | P8 | S6 | E4 |
| 549 | P8 | S6 | E2 + E3 |
| 550 | P8 | S6 | E2 + E4 |
| 551 | P8 | S6 | E3 + E4 |
| 552 | P8 | S6 | E2 + E3 + E4 |
| 553 | P8 | S7 | E1 |
| 554 | P8 | S7 | E2 |
| 555 | P8 | S7 | E3 |
| 556 | P8 | S7 | E4 |
| 557 | P8 | S7 | E2 + E3 |
| 558 | P8 | S7 | E2 + E4 |
| 559 | P8 | S7 | E3 + E4 |
| 560 | P8 | S7 | E2 + E3 + E4 |
| 561 | P8 | S8 | E1 |
| 562 | P8 | S8 | E2 |
| 563 | P8 | S8 | E3 |
| 564 | P8 | S8 | E4 |
| 565 | P8 | S8 | E2 + E3 |
| 566 | P8 | S8 | E2 + E4 |
| 567 | P8 | S8 | E3 + E4 |
| 568 | P8 | S8 | E2 + E3 + E4 |
| 569 | P8 | S9 | E1 |
| 570 | P8 | S9 | E2 |
| 571 | P8 | S9 | E3 |
| 572 | P8 | S9 | E4 |
| 573 | P8 | S9 | E2 + E3 |
| 574 | P8 | S9 | E2 + E4 |
| 575 | P8 | S9 | E3 + E4 |
| 576 | P8 | S9 | E2 + E3 + E4 |
| 577 | P9 | S1 | E1 |
| 578 | P9 | S1 | E2 |
| 579 | P9 | S1 | E3 |
| 580 | P9 | S1 | E4 |
| 581 | P9 | S1 | E2 + E3 |
| 582 | P9 | S1 | E2 + E4 |
| 583 | P9 | S1 | E3 + E4 |
| 584 | P9 | S1 | E2 + E3 + E4 |
| 585 | P9 | S2 | E1 |
| 586 | P9 | S2 | E2 |
| 587 | P9 | S2 | E3 |
| 588 | P9 | S2 | E4 |
| 589 | P9 | S2 | E2 + E3 |
| 590 | P9 | S2 | E2 + E4 |
| 591 | P9 | S2 | E3 + E4 |
| 592 | P9 | S2 | E2 + E3 + E4 |
| 593 | P9 | S3 | E1 |
| 594 | P9 | S3 | E2 |
| 595 | P9 | S3 | E3 |
| 596 | P9 | S3 | E4 |
| 597 | P9 | S3 | E2 + E3 |
| 598 | P9 | S3 | E2 + E4 |
| 599 | P9 | S3 | E3 + E4 |
| 600 | P9 | S3 | E2 + E3 + E4 |
| 601 | P9 | S4 | E1 |
| 602 | P9 | S4 | E2 |
| 603 | P9 | S4 | E3 |
| 604 | P9 | S4 | E4 |
| 605 | P9 | S4 | E2 + E3 |
| 606 | P9 | S4 | E2 + E4 |
| 607 | P9 | S4 | E3 + E4 |
| 608 | P9 | S4 | E2 + E3 + E4 |
| 609 | P9 | S5 | E1 |
| 610 | P9 | S5 | E2 |
| 611 | P9 | S5 | E3 |
| 612 | P9 | S5 | E4 |
| 613 | P9 | S5 | E2 + E3 |
| 614 | P9 | S5 | E2 + E4 |
| 615 | P9 | S5 | E3 + E4 |
| 616 | P9 | S5 | E2 + E3 + E4 |
| 617 | P9 | S6 | E1 |
| 618 | P9 | S6 | E2 |
| 619 | P9 | S6 | E3 |
| 620 | P9 | S6 | E4 |
| 621 | P9 | S6 | E2 + E3 |
| 622 | P9 | S6 | E2 + E4 |
| 623 | P9 | S6 | E3 + E4 |
| 624 | P9 | S6 | E2 + E3 + E4 |
| 625 | P9 | S7 | E1 |
| 626 | P9 | S7 | E2 |
| 627 | P9 | S7 | E3 |
| 628 | P9 | S7 | E4 |
| 629 | P9 | S7 | E2 + E3 |
| 630 | P9 | S7 | E2 + E4 |
| 631 | P9 | S7 | E3 + E4 |
| 632 | P9 | S7 | E2 + E3 + E4 |
| 633 | P9 | S8 | E1 |
| 634 | P9 | S8 | E2 |
| 635 | P9 | S8 | E3 |
| 636 | P9 | S8 | E4 |
| 637 | P9 | S8 | E2 + E3 |
| 638 | P9 | S8 | E2 + E4 |
| 639 | P9 | S8 | E3 + E4 |
| 640 | P9 | S8 | E2 + E3 + E4 |
| 641 | P9 | S9 | E1 |
| 642 | P9 | S9 | E2 |
| 643 | P9 | S9 | E3 |
| 644 | P9 | S9 | E4 |
| 645 | P9 | S9 | E2 + E3 |
| 646 | P9 | S9 | E2 + E4 |
| 647 | P9 | S9 | E3 + E4 |
| 648 | P9 | S9 | E2 + E3 + E4 |
| 649 | P10 | S1 | E1 |
| 650 | P10 | S1 | E2 |
| 651 | P10 | S1 | E3 |
| 652 | P10 | S1 | E4 |
| 653 | P10 | S1 | E2 + E3 |
| 654 | P10 | S1 | E2 + E4 |
| 655 | P10 | S1 | E3 + E4 |
| 656 | P10 | S1 | E2 + E3 + E4 |
| 657 | P10 | S2 | E1 |
| 658 | P10 | S2 | E2 |
| 659 | P10 | S2 | E3 |
| 660 | P10 | S2 | E4 |
| 661 | P10 | S2 | E2 + E3 |
| 662 | P10 | S2 | E2 + E4 |
| 663 | P10 | S2 | E3 + E4 |
| 664 | P10 | S2 | E2 + E3 + E4 |
| 665 | P10 | S3 | E1 |
| 666 | P10 | S3 | E2 |
| 667 | P10 | S3 | E3 |
| 668 | P10 | S3 | E4 |
| 669 | P10 | S3 | E2 + E3 |
| 670 | P10 | S3 | E2 + E4 |
| 671 | P10 | S3 | E3 + E4 |
| 672 | P10 | S3 | E2 + E3 + E4 |
| 673 | P10 | S4 | E1 |
| 674 | P10 | S4 | E2 |
| 675 | P10 | S4 | E3 |
| 676 | P10 | S4 | E4 |
| 677 | P10 | S4 | E2 + E3 |
| 678 | P10 | S4 | E2 + E4 |
| 679 | P10 | S4 | E3 + E4 |
| 680 | P10 | S4 | E2 + E3 + E4 |
| 681 | P10 | S5 | E1 |
| 682 | P10 | S5 | E2 |
| 683 | P10 | S5 | E3 |
| 684 | P10 | S5 | E4 |
| 685 | P10 | S5 | E2 + E3 |
| 686 | P10 | S5 | E2 + E4 |
| 687 | P10 | S5 | E3 + E4 |
| 688 | P10 | S5 | E2 + E3 + E4 |
| 689 | P10 | S6 | E1 |
| 690 | P10 | S6 | E2 |
| 691 | P10 | S6 | E3 |
| 692 | P10 | S6 | E4 |
| 693 | P10 | S6 | E2 + E3 |
| 694 | P10 | S6 | E2 + E4 |
| 695 | P10 | S6 | E3 + E4 |
| 696 | P10 | S6 | E2 + E3 + E4 |
| 697 | P10 | S7 | E1 |
| 698 | P10 | S7 | E2 |
| 699 | P10 | S7 | E3 |
| 700 | P10 | S7 | E4 |
| 701 | P10 | S7 | E2 + E3 |
| 702 | P10 | S7 | E2 + E4 |
| 703 | P10 | S7 | E3 + E4 |
| 704 | P10 | S7 | E2 + E3 + E4 |
| 705 | P10 | S8 | E1 |
| 706 | P10 | S8 | E2 |
| 707 | P10 | S8 | E3 |
| 708 | P10 | S8 | E4 |
| 709 | P10 | S8 | E2 + E3 |
| 710 | P10 | S8 | E2 + E4 |
| 711 | P10 | S8 | E3 + E4 |
| 712 | P10 | S8 | E2 + E3 + E4 |
| 713 | P10 | S9 | E1 |
| 714 | P10 | S9 | E2 |
| 715 | P10 | S9 | E3 |
| 716 | P10 | S9 | E4 |
| 717 | P10 | S9 | E2 + E3 |
| 718 | P10 | S9 | E2 + E4 |
| 719 | P10 | S9 | E3 + E4 |
| 720 | P10 | S9 | E2 + E3 + E4 |
| 721 | P11 | S1 | E1 |
| 722 | P11 | S1 | E2 |
| 723 | P11 | S1 | E3 |
| 724 | P11 | S1 | E4 |
| 725 | P11 | S1 | E2 + E3 |
| 726 | P11 | S1 | E2 + E4 |
| 727 | P11 | S1 | E3 + E4 |
| 728 | P11 | S1 | E2 + E3 + E4 |
| 729 | P11 | S2 | E1 |
| 730 | P11 | S2 | E2 |
| 731 | P11 | S2 | E3 |
| 732 | P11 | S2 | E4 |
| 733 | P11 | S2 | E2 + E3 |
| 734 | P11 | S2 | E2 + E4 |
| 735 | P11 | S2 | E3 + E4 |
| 736 | P11 | S2 | E2 + E3 + E4 |
| 737 | P11 | S3 | E1 |
| 738 | P11 | S3 | E2 |
| 739 | P11 | S3 | E3 |
| 740 | P11 | S3 | E4 |
| 741 | P11 | S3 | E2 + E3 |
| 742 | P11 | S3 | E2 + E4 |
| 743 | P11 | S3 | E3 + E4 |
| 744 | P11 | S3 | E2 + E3 + E4 |
| 745 | P11 | S4 | E1 |
| 746 | P11 | S4 | E2 |
| 747 | P11 | S4 | E3 |
| 748 | P11 | S4 | E4 |
| 749 | P11 | S4 | E2 + E3 |
| 750 | P11 | S4 | E2 + E4 |
| 751 | P11 | S4 | E3 + E4 |
| 752 | P11 | S4 | E2 + E3 + E4 |
| 753 | P11 | S5 | E1 |
| 754 | P11 | S5 | E2 |
| 755 | P11 | S5 | E3 |
| 756 | P11 | S5 | E4 |
| 757 | P11 | S5 | E2 + E3 |
| 758 | P11 | S5 | E2 + E4 |
| 759 | P11 | S5 | E3 + E4 |
| 760 | P11 | S5 | E2 + E3 + E4 |
| 761 | P11 | S6 | E1 |
| 762 | P11 | S6 | E2 |
| 763 | P11 | S6 | E3 |
| 764 | P11 | S6 | E4 |
| 765 | P11 | S6 | E2 + E3 |
| 766 | P11 | S6 | E2 + E4 |
| 767 | P11 | S6 | E3 + E4 |
| 768 | P11 | S6 | E2 + E3 + E4 |
| 769 | P11 | S7 | E1 |
| 770 | P11 | S7 | E2 |
| 771 | P11 | S7 | E3 |
| 772 | P11 | S7 | E4 |
| 773 | P11 | S7 | E2 + E3 |
| 774 | P11 | S7 | E2 + E4 |
| 775 | P11 | S7 | E3 + E4 |
| 776 | P11 | S7 | E2 + E3 + E4 |
| 777 | P11 | S8 | E1 |
| 778 | P11 | S8 | E2 |
| 779 | P11 | S8 | E3 |
| 780 | P11 | S8 | E4 |
| 781 | P11 | S8 | E2 + E3 |
| 782 | P11 | S8 | E2 + E4 |
| 783 | P11 | S8 | E3 + E4 |
| 784 | P11 | S8 | E2 + E3 + E4 |
| 785 | P11 | S9 | E1 |
| 786 | P11 | S9 | E2 |
| 787 | P11 | S9 | E3 |
| 788 | P11 | S9 | E4 |
| 789 | P11 | S9 | E2 + E3 |
| 790 | P11 | S9 | E2 + E4 |
| 791 | P11 | S9 | E3 + E4 |
| 792 | P11 | S9 | E2 + E3 + E4 |
| 793 | P12 | S1 | E1 |
| 794 | P12 | S1 | E2 |
| 795 | P12 | S1 | E3 |
| 796 | P12 | S1 | E4 |
| 797 | P12 | S1 | E2 + E3 |
| 798 | P12 | S1 | E2 + E4 |
| 799 | P12 | S1 | E3 + E4 |
| 800 | P12 | S1 | E2 + E3 + E4 |
| 801 | P12 | S2 | E1 |
| 802 | P12 | S2 | E2 |
| 803 | P12 | S2 | E3 |
| 804 | P12 | S2 | E4 |
| 805 | P12 | S2 | E2 + E3 |
| 806 | P12 | S2 | E2 + E4 |
| 807 | P12 | S2 | E3 + E4 |
| 808 | P12 | S2 | E2 + E3 + E4 |
| 809 | P12 | S3 | E1 |
| 810 | P12 | S3 | E2 |
| 811 | P12 | S3 | E3 |
| 812 | P12 | S3 | E4 |
| 813 | P12 | S3 | E2 + E3 |
| 814 | P12 | S3 | E2 + E4 |
| 815 | P12 | S3 | E3 + E4 |
| 816 | P12 | S3 | E2 + E3 + E4 |
| 817 | P12 | S4 | E1 |
| 818 | P12 | S4 | E2 |
| 819 | P12 | S4 | E3 |
| 820 | P12 | S4 | E4 |
| 821 | P12 | S4 | E2 + E3 |
| 822 | P12 | S4 | E2 + E4 |
| 823 | P12 | S4 | E3 + E4 |
| 824 | P12 | S4 | E2 + E3 + E4 |
| 825 | P12 | S5 | E1 |
| 826 | P12 | S5 | E2 |
| 827 | P12 | S5 | E3 |
| 828 | P12 | S5 | E4 |
| 829 | P12 | S5 | E2 + E3 |
| 830 | P12 | S5 | E2 + E4 |
| 831 | P12 | S5 | E3 + E4 |
| 832 | P12 | S5 | E2 + E3 + E4 |
| 833 | P12 | S6 | E1 |
| 834 | P12 | S6 | E2 |
| 835 | P12 | S6 | E3 |
| 836 | P12 | S6 | E4 |
| 837 | P12 | S6 | E2 + E3 |
| 838 | P12 | S6 | E2 + E4 |
| 839 | P12 | S6 | E3 + E4 |
| 840 | P12 | S6 | E2 + E3 + E4 |
| 841 | P12 | S7 | E1 |
| 842 | P12 | S7 | E2 |
| 843 | P12 | S7 | E3 |
| 844 | P12 | S7 | E4 |
| 845 | P12 | S7 | E2 + E3 |
| 846 | P12 | S7 | E2 + E4 |
| 847 | P12 | S7 | E3 + E4 |
| 848 | P12 | S7 | E2 + E3 + E4 |
| 849 | P12 | S8 | E1 |
| 850 | P12 | S8 | E2 |
| 851 | P12 | S8 | E3 |
| 852 | P12 | S8 | E4 |
| 853 | P12 | S8 | E2 + E3 |
| 854 | P12 | S8 | E2 + E4 |
| 855 | P12 | S8 | E3 + E4 |
| 856 | P12 | S8 | E2 + E3 + E4 |
| 857 | P12 | S9 | E1 |
| 858 | P12 | S9 | E2 |
| 859 | P12 | S9 | E3 |
| 860 | P12 | S9 | E4 |
| 861 | P12 | S9 | E2 + E3 |
| 862 | P12 | S9 | E2 + E4 |
| 863 | P12 | S9 | E3 + E4 |
| 864 | P12 | S9 | E2 + E3 + E4 |
| 865 | P13 | S1 | E1 |
| 866 | P13 | S1 | E2 |
| 867 | P13 | S1 | E3 |
| 868 | P13 | S1 | E4 |
| 869 | P13 | S1 | E2 + E3 |
| 870 | P13 | S1 | E2 + E4 |
| 871 | P13 | S1 | E3 + E4 |
| 872 | P13 | S1 | E2 + E3 + E4 |
| 873 | P13 | S2 | E1 |
| 874 | P13 | S2 | E2 |
| 875 | P13 | S2 | E3 |
| 876 | P13 | S2 | E4 |
| 877 | P13 | S2 | E2 + E3 |
| 878 | P13 | S2 | E2 + E4 |
| 879 | P13 | S2 | E3 + E4 |
| 880 | P13 | S2 | E2 + E3 + E4 |
| 881 | P13 | S3 | E1 |
| 882 | P13 | S3 | E2 |
| 883 | P13 | S3 | E3 |
| 884 | P13 | S3 | E4 |
| 885 | P13 | S3 | E2 + E3 |
| 886 | P13 | S3 | E2 + E4 |
| 887 | P13 | S3 | E3 + E4 |
| 888 | P13 | S3 | E2 + E3 + E4 |
| 889 | P13 | S4 | E1 |
| 890 | P13 | S4 | E2 |
| 891 | P13 | S4 | E3 |
| 892 | P13 | S4 | E4 |
| 893 | P13 | S4 | E2 + E3 |
| 894 | P13 | S4 | E2 + E4 |
| 895 | P13 | S4 | E3 + E4 |
| 896 | P13 | S4 | E2 + E3 + E4 |
| 897 | P13 | S5 | E1 |
| 898 | P13 | S5 | E2 |
| 899 | P13 | S5 | E3 |
| 900 | P13 | S5 | E4 |
| 901 | P13 | S5 | E2 + E3 |
| 902 | P13 | S5 | E2 + E4 |
| 903 | P13 | S5 | E3 + E4 |
| 904 | P13 | S5 | E2 + E3 + E4 |
| 905 | P13 | S6 | E1 |
| 906 | P13 | S6 | E2 |
| 907 | P13 | S6 | E3 |
| 908 | P13 | S6 | E4 |
| 909 | P13 | S6 | E2 + E3 |
| 910 | P13 | S6 | E2 + E4 |
| 911 | P13 | S6 | E3 + E4 |
| 912 | P13 | S6 | E2 + E3 + E4 |
| 913 | P13 | S7 | E1 |
| 914 | P13 | S7 | E2 |
| 915 | P13 | S7 | E3 |
| 916 | P13 | S7 | E4 |
| 917 | P13 | S7 | E2 + E3 |
| 918 | P13 | S7 | E2 + E4 |
| 919 | P13 | S7 | E3 + E4 |
| 920 | P13 | S7 | E2 + E3 + E4 |
| 921 | P13 | S8 | E1 |
| 922 | P13 | S8 | E2 |
| 923 | P13 | S8 | E3 |
| 924 | P13 | S8 | E4 |
| 925 | P13 | S8 | E2 + E3 |
| 926 | P13 | S8 | E2 + E4 |
| 927 | P13 | S8 | E3 + E4 |
| 928 | P13 | S8 | E2 + E3 + E4 |
| 929 | P13 | S9 | E1 |
| 930 | P13 | S9 | E2 |
| 931 | P13 | S9 | E3 |
| 932 | P13 | S9 | E4 |
| 933 | P13 | S9 | E2 + E3 |
| 934 | P13 | S9 | E2 + E4 |
| 935 | P13 | S9 | E3 + E4 |
| 936 | P13 | S9 | E2 + E3 + E4 |

wherein P1 is azoxystrobin, P2 is prothioconazole, P3 is pyraclostrobin, P4 is oxyfluorfen, P5 is difenoconazole, P6 is trifloxystrobin, P7 is propiconazole, P8 is cyproconazole, P9 is flufenacetate, P10 is epoxiconazole, P11 is fluxapyroxad, P12 is fenbuconazole and P13 is tebuconazole, S1 is gamma-octalactone, S2 is gamma-nonalactone, S3 is beta-methyl-gamma-octalactone, S4 is delta-methyl-gamma-octalactone, S5 is gamma-decalactone, S6 is gamma-undecalactone, S7 is gamma-dodecalactone, S8 is delta-decalactone, S9 is delta-dodecalactone, whilst E1 is any emulsifier, E2 is a block copolymer containing ethylene oxide and propylene oxide monomers, E3 is a sulfonate salt, and E4 is an ethoxylated castor oil.

In addition to these essential components, the emulsifiable concentrate (EC) may further comprise adjuvants conventionally used for agrochemical formulations, the choice of the adjuvants depending on the specific use form, the type of formulation or the active substance. Examples of suitable adjuvants are surface-active substances (such as solubilisers, protective colloids, wetters and tackifiers), retention agents, wetting agents, spreaders, uptake enhancers, penetration agents, spray drift controllers, crystallization inhibitors, organic and inorganic thickeners, bactericides, antifreeze agents, antifoams, optionally colorants and adhesives (for example for the treatment of seed) or conventional adjuvants for bait formulations (for example attractants, feedants, bittering substances).

The emulsifiable concentrate (EC) according to the present invention preferably comprises, more preferably consists of:
a) from 5 to 70% w/w, more preferably from 10 to 65% w/w, most preferably from 15 to 60% w/w, relative to the total weight of the emulsifiable concentrate (EC), of one or more pesticides;
b) from 1 to 30% w/w, more preferably from 5 to 20% w/w, most preferably from 10 to 15% w/w, relative to the total weight of the emulsifiable concentrate (EC), of one or more emulsifiers;
c) from 10 to 85% w/w, more preferably from 15 to 75% w/w, most preferably from 25 to 60% w/w, relative to the total weight of the emulsifiable concentrate (EC), of the solvent(s) with a structure according to formula (I); and
d) optionally from 1 to 84% w/w, more preferably from 5 to 60% w/w, most preferably from 10 to 35% w/w, relative to the total weight of the emulsifiable concentrate (EC), of one or more adjuvants, wherein the total amount of components a), b), c), and d) do not exceed 100%.

As mentioned above, it is a finding of the present invention that many typical commercially important pesticides have improved solubility in the solvent according to the present invention, when compared with typical solvent systems used for agrochemical emulsifiable concentrates.

In addition to this finding, it has been further found that the inventive emulsifiable concentrates (EC) form highly stable emulsions when mixed with water to form emulsions, so called emulsion-in-water (EW) formulations.

The stability of an emulsion-in-water formulation may be evaluated by determining how much sedimentation or cream is formed following homogenization (i.e. following emulsification). Both cream and sedimentation represent a departure from idealized emulsion behavior, where the disperse particles either rise to the surface (creaming) or sink to the bottom (sedimentation) depending on their density. When determining the extent of creaming or sedimentation, it is not critical whether the emulsified droplets remain as such or aggregate to form a new continuous phase—both are sufficient to determine that the emulsion has broken down.

The stability of a given emulsion is dependent on a number of factors, including the nature of the two immiscible phases, the relative amounts of each phase, and the emulsifiers used to stabilize the emulsion. For the purposes of quantifying emulsion stability in the context of the present invention, a stable emulsion is viewed as an emulsion that forms less than or equal to a given amount of cream and/or sedimentation 24 hours after homogenization.

It is a finding of the present invention that the inventive emulsifiable concentrates (EC) are suitable for forming a wide range of emulsion-in-water (EW) formulations, when mixed with water and homogenized, which demonstrate unexpectedly beneficial emulsion stability.

In order to quantify this beneficial feature of the emulsifiable concentrates (EC), a model emulsion system comprising 5.0 mL of the emulsifiable concentrate (EC) and 95.0 ml of water may be used, in which case a stable emulsion is defined as an emulsion that produces less than or equal to 1.5 mL of cream or sediment, 24 hours after formation of said emulsion.

As such, it is preferred that the emulsifiable concentrate (EC) forms a stable emulsion when 5.0 mL of said emulsifiable concentrate (EC) is combined with 95.0 mL of water and homogenized, wherein a stable emulsion is defined as an emulsion having less than or equal to 1.5 mL of cream or sediment, 24 hours after formation of said emulsion.

More preferably the emulsion forms less than or equal to 1.0 mL of cream or sediment, 24 hours after formation of said emulsion. Most preferably the emulsion forms less than or equal to 0.5 mL of cream or sediment, 24 hours after formation of said emulsion.

If the emulsion does produce a measurable level of sediment or cream, it is further preferred that the emulsion may be re-homogenized, i.e. re-emulsified, to reform a stable emulsion, wherein a stable emulsion is as defined as above, wherein less than or equal to 1.5 mL of cream or sediment is formed 30 minutes after re-homogenization, more preferably wherein less than or equal to 1.0 mL of cream or sediment is formed 30 minutes after re-homogenization, most preferably wherein less than or equal to 0.5 mL of cream or sediment is formed 30 minutes after re-homogenization.

Methods for the initial homogenization and re-homogenization are well known in the art, and the precise method used in such a test is not critical.

That said, it is preferred that the homogenization is carried out by gentle inversion of the emulsion 10 times and that the re-homogenization is likewise carried out by gentle inversion of the emulsion 10 times.

As would be understood by the person skilled in the art, the threshold of how much cream or sediment would indicate that an emulsion would not be stable is dependent on the amounts of each phase present in the emulsion. As such, alternative tests, such as may be envisaged.

A model emulsion system comprising 0.5 mL of the emulsifiable concentrate (EC) and 99.5 mL of water may be used to assess stability, in which case a stable emulsion is defined as an emulsion that produces less than or equal to 0.5 mL of cream or sediment, 24 hours after formation of said emulsion. It is thus further preferred that the emulsifiable concentrate (EC) forms a stable emulsion when 0.5 mL of said emulsifiable concentrate (EC) is combined with 99.5 mL of water and homogenized, wherein a stable emulsion is defined as an emulsion having less than or equal to 0.5 mL of cream or sediment, 24 hours after formation of said emulsion.

More preferably the emulsion forms less than or equal to 0.2 mL of cream or sediment, 24 hours after formation of said emulsion.

If the emulsion does produce a measurable level of sediment or cream, it is further preferred that the emulsion may be re-homogenized, i.e. re-emulsified, to reform a stable emulsion, wherein a stable emulsion is as defined as above, wherein less than or equal to 0.5 mL of cream or sediment is formed 30 minutes after re-homogenization, preferably wherein less than or equal to 0.2 mL of cream or sediment is formed 30 minutes after re-homogenization.

It is further preferred that an emulsion-in-water (EW) formulation comprising an aqueous phase and a non-aqueous phase, wherein the non-aqueous phase is the emulsifiable concentrate (EC) achieves improved penetration of the one or more pesticides into plants, relative to comparable emulsion-in-water formulations using different solvent(s) and/or no solvent. In particular, it is preferred that an emulsion-in-water (EW) formulation comprising an aqueous phase and a non-aqueous phase, wherein the non-aqueous phase is the emulsifiable concentrate (EC) achieves improved penetration of the one or more pesticides into plants, relative to comparable emulsion-in-water formulations using no solvent.

The improved penetration may be 50% higher than for the comparable emulsion-in-water formulations and may be measured by evaluating the penetration of PS II inhibitors as measured by Fluorescence Index, amongst other suitable measurement methods that would be known to the person skilled in the art.

### Emulsion-In-Water (EW) Formulation

As described above, the emulsifiable concentrates (EC) of the present invention are most suitable for forming highly stable emulsion-in-water (EW) formulations.

In a further aspect, the present invention is directed to an emulsion-in-water (EW) formulation, comprising an aqueous phase and a non-aqueous phase, wherein the non-aqueous phase is the emulsifiable concentrate (EC) of the first aspect.

The precise amounts of the emulsifiable concentrate (EC) and water present in the emulsion-in-water (EW) formulation are not critical; however, it is preferred that the emulsion-in-water (EW) formulation comprises, more preferably consists of, an amount in the range from 0.01 to 80.0% w/w of the emulsifiable concentrate (EC) according to the first aspect and an amount in the range of from 20.0 to 99.99% w/w of water, both amounts being expressed relative to the total weight of the emulsion-in-water (EW) formulation.

It is further preferred that that the emulsion-in-water (EW) formulation comprises, more preferably consists of, an amount in the range from 0.1 to 50.0% w/w of the emulsifiable concentrate (EC) according to the first aspect and an amount in the range of from 50.0 to 99.9% w/w of water, both amounts being expressed relative to the total weight of the emulsion-in-water (EW) formulation.

It is especially preferred that the emulsion-in-water (EW) formulation comprises, more preferably consists of, an amount in the range from 0.5 to 5.0% w/w of the emulsifiable concentrate (EC) according to the first aspect and an amount in the range of from 95.0 to 99.5% w/w of water, both amounts being expressed relative to the total weight of the emulsion-in-water (EW) formulation.

In addition to the emulsifiable concentrate (EC) according to the first aspect and water, the emulsion-in-water (EW) formulation may further contain adjuvants conventionally used for agrochemical formulations (co-called tank adjuvants), the choice of the adjuvants depending on the specific use form, the type of formulation or the active substance. Examples of suitable adjuvants are surface-active substances (such as solubilisers, protective colloids, wetters and tackifiers), retention agents, wetting agents, spreaders, uptake enhancers, penetration agents, spray drift controllers, crystallization inhibitors, organic and inorganic thickeners, bactericides, antifreeze agents, antifoams, optionally colorants and adhesives (for example for the treatment of seed) or conventional adjuvants for bait formulations (for example attractants, feedants, bittering substances).

It is further preferred that the emulsion-in-in water (EW) formulation achieves improved penetration of the one or more pesticides into plants, relative to comparable emulsion-in-water formulations using different solvent(s) and/or no solvent. In particular, it is preferred that the emulsion-in-in water (EW) formulation achieves improved penetration of the one or more pesticides into plants, relative to comparable emulsion-in-water formulations using no solvent.

The improved penetration may be 50% higher than for the comparable emulsion-in-water formulations and may be measured by evaluating the penetration of PS II inhibitors as measured by Fluorescence Index, amongst other suitable measurement methods that would be known to the person skilled in the art.

All preferable embodiments and fallback positions relating to the emulsifiable concentrate (EC) of the first aspect are applicable mutatis mutandis to the emulsion-in-water (EW) formulation of the further aspect.

### Use

In yet a further aspect, the present invention is directed to a use of a compound having a structure according to formula (I):

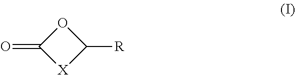

wherein X is selected from —CR′₂CR′₂—, —CR′═CR′—, —CR′₂CR′₂CR′₂—, and —CR′═CR′CR′₂—,
R is selected from linear and branched C₁ to C₁₅ alkyl or alkenyl groups, and each instance of R′
is independently selected from H, Me and Et,
as a solvent in an agrochemical emulsifiable concentrate, preferably the emulsifiable concentrate (EC) according to the first aspect.

All preferable embodiments and fallback positions relating to the emulsifiable concentrate (EC) of the first aspect are applicable mutatis mutandis to the use of a compound having a structure according to formula (I) of the present aspect.

Likewise, all preferable embodiments and fallback positions relating to the compound having a structure according to formula (I) given for the first aspect are applicable mutatis mutandis to the compound having a structure according to formula (I) as used in the present aspect.

In a final aspect, the present invention is directed to a use of the emulsion-in-water (EW) formulation according to the further aspect described above for treating plants, thereby maintaining plant health, without causing plant damage.

Plant damage may be evaluated relative to the treatment of the plant with an aqueous solution containing the same emulsifiers, simply without the solvent and the pesticide. Avoiding plant damage is generally achieved by using one or more pesticides known to have low phytotoxicity in combination with a solvent having low phytotoxicity.

In particular, it is preferred that the solvent has low phytotoxicity, wherein low phytotoxicity is defined as being when an emulsion containing 99.0% w/w, relative to the total weight of the emulsion, of water and 1.0% w/w, relative to the total weight of the emulsion, of a non-aqueous phase containing 90% w/w of the solvent, 7.5% w/w castor oil ethoxylate and 2.5% w/w of calcium dodecylbenzenesulfonate, each relative to the total weight of the non-aqueous phase, causes at no greater plant damage than an aqueous solution of 0.075% w/w castor oil ethoxylate and 0.025% w/w of calcium dodecylbenzenesulfonate, each relative to the total weight of the aqueous solution, when measured 14 days after application to soya plants at an application rate of 200 L per hectare.

The phytotoxicity of various commonly-used pesticides is within the common general knowledge of the person skilled in the art.

As would be understood by the person skilled in the art, the use of the emulsion-in-water (EW) formulation would be for the treatment of crop plants, thereby maintaining crop plant health, without causing crop plant damage. In cases where the emulsion-in-water (EW) formulation contains herbicides that damage weeds (i.e. non-crop plants), this would not be considered to cause “plant damage”, as this term refers to the crop plant rather than weeds.

All preferable embodiments and fallback positions relating to the emulsion-in-water (EW) formulation of the further aspect described above are applicable mutatis mutandis to the use of the emulsion-in-water (EW) formulation for treating plants of the final aspect.

### EXPERIMENTAL SECTION

### Materials Used:

Solvents: Beta-methyl-gamma-octalactone, Beta,delta-dimethyl-gamma-octalactone, 2-Ethylhexyl Lactate, C8-C10 fatty acid methyl ester, and dimethyl decanamide were sourced from BASF. All other lactones were sourced from Sigma-Aldrich.

CIPAC D water: Made in the lab using a standard recipe published by CIPAC “MT 18.1.4”: Standard Waters. The water has a hardness of 342 ppm, with a 4:1 mixture of Ca:Mg ions at pH 6-7.

The pesticides: azoxystrobin, prothioconazole, pyraclostrobin, oxyfluorfen, difenoconazole, trifloxystrobin, propiconazole, cyproconazole, flufenacetate, epoxiconazole, fluxapyroxad, fenbuconazole, tebuconazole, metaflumizone, pinoxaden, deltamethrin and pendimethalin were purchased from various commercial sources

The emulsifiers: The emulsifiers used
in the experiments are listed below.

| | |
|---|---|
| Emulsifier 1 | Ethoxylated castor oil (20% ethoxylated) |
| Emulsifier 2 | Ethoxylated castor oil (35% ethoxylated) |
| Emulsifier 3 | Ethoxylated castor oil (40% ethoxylated) |
| Emulsifier 4 | Ethoxylated castor oil (54% ethoxylated) |
| Emulsifier 5 | Alkylbenzene Sulfonate |
| Emulsifier 6 | Di-isooctyl sulfosuccinate, sodium salt |
| Emulsifier 7 | EO-PO-EO block copolymer, 40% EO, |
| | Molar Mass 4600 g/mol |

### Example 1: Determination of Water Solubility

The water solubility of the solvent was determined according to a method based on CIPAC MT157.1 and OECD 105 via the visual assessment of undissolved solvent in water after vigorous mixing and standing. Herein, various amounts of solvent and water were mixed with vigorous shaking in a glass-stoppered graduated cylinder or separating funnel, followed by standing for at least 30 min to enable separation. For example, if undissolved solvent was observed after thorough mixing of 0.1 g solvent in 100 ml of water, the solvent had a water-solubility equal to or below 0.1% (≤1 g/L). This method can be repeated with various amounts of solvent and water to enable the determination of the water-solubility of the solvent.

A number of different lactone-based solvents were evaluated, having the following structures and water solubilities:

TABLE 1
Solubility of lactones in water

| | | Water solubility |
|---|---|---|
| Solvent | Structure | [% w/w] |
| Gamma-valerolactone | 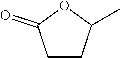 | 100 |
| Gamma-hexalactone | 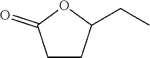 | 8 |
| Gamma-octalactone | 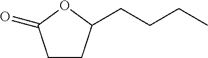 | 0.8 |
| Gamma-nonalactone | 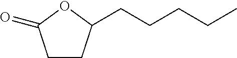 | 0.2 |
| Beta-methyl-gamma- octalactone | 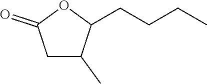 | ≤0.2 |
| Delta-methyl-gamma- octalactone | 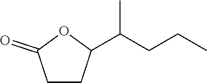 | ≤0.2 |
| Beta, delta-dimethyl- gamma-octalactone | 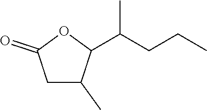 | ≤0.2 |
| Gamma-decalactone | 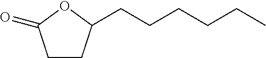 | 0.1 |
| Gamma-undecalactone | 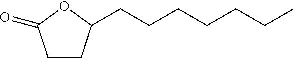 | 0.02 |
| Gamma-dodecalactone | 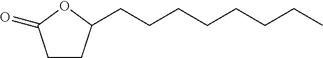 | <0.02 |
| Delta-valerolactone | 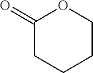 | 100 |
| Delta-nonalactone | 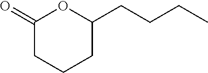 | 1.2 |
| Delta-decalactone | 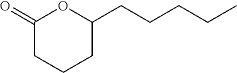 | 0.4 |
| Delta-dodecalactone | 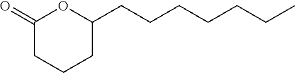 | 0.07 |
| Delta-tridecalactone | 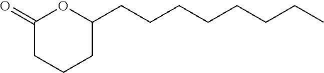 | <0.1 |

### Example 2: Determination of Maximum Pesticide Solubility

The maximum solubility of pesticides in various solvents were determined at 21° C. Herein, small amounts of active ingredients were added to the 10 g of solvent in a 25 ml beaker under stirring with a magnetic stirrer bar. Active ingredient doses were added to the solvent until dissolution was no longer achieved, with a maximum 2 h stirring time conducted to achieve dissolution between dosing. The solubility was calculated according to the following equation:

$$Solubility [ \% ] = \frac{sum of added and dissolved active ingredient [ g ]}{\begin{matrix}mass solvent [ g ] + \\ sum of added and dissolved active ingredient [ g ]\end{matrix}} * 100$$

As can be seen from Table 2, the solubilities of most pesticides were improved in the lactone-based solvents, relative to the methyl ester solvents. In many cases, the solubility was also improved over the dimethyl amide; however, even in cases where improved solubility was not observed, the use of the lactone solvents are preferable due to their reduced odour and health hazards (see later examples).

### Example 3: Stable Pesticide Emulsions Using Inventive Lactones as a Solvent

The emulsion was tested for its dispersibility by the effect known as blooming. The emulsions were assessed according to their spontaneous emulsification when the concentrate is added to water (known in the art as “blooming”) with a visual assessment given on a scale of 1 to 5, whereby 1). Excellent, “cloud of emulsion”, does not sink to bottom of cylinder. 2). Good, “cloud of emulsion”, but sinks to bottom of cylinder 3). Okay, “poor emulsion cloud”, larger droplets 4). Poor, “no emulsion cloud”, small “particles” observed 5). Very poor, no emulsion, oil and water phases immediately separate”

Emulsifiable concentrates were prepared in the following examples and the resulting 5% w/w emulsions in various water hardness at 21° C. after 24 hours were assessed. Emulsion stability was determined as a function of time, with the amount of either cream or sediment measured. To measure emulsion stability, 5.0 mL of the emulsifiable concentrate was diluted in 95.0 mL CIPAC D water in a 100 mL measuring cylinder. The resulting oil-in-water emulsion stability was assessed after 1, 2, 4 and 24 hours. A highly stable emulsion does not form cream, or have less than 1.5 mL cream after 24 hours, and can be readily re-emulsified after 24 h of standing without the formation of cream, with such re-emulsified emulsions assessed 30 minutes after re-emulsification. Both the initial emulsification and the re-emulsification were achieved by gently inverting the emulsion 10 times.

TABLE 2
Maximum solubility of various pesticides in various solvents

| | Azoxy- | | | | Trifloxy- | | Epxoy- | |
|---|---|---|---|---|---|---|---|---|
| Solvent | strobin | Prothioconazole | Oxyfluorfen | Difenoconazole | strobin | Flufenacetate | conazole | Pyraclostrobin |
| Gamma-octalactone | 10 | 33 | 34 | 40 | 34 | 45 | 8 | >50 |
| Gamma-nonalactone | 6 | 33 | 32 | 38 | 30 | 44 | 6 | >50 |
| Beta-methyl-gamma-octalactone | 8 | NM | 34 | 38 | NM | NM | NM | NM |
| Gamma-decalactone | 6 | 28 | 30 | 37 | 26 | 37 | 7 | 47 |
| Gamma-undecalactone | 5 | 28 | 29 | 29 | 22 | 37 | 6 | 42 |
| Gamma-dodecalactone | 4 | 24 | 26 | 25 | 17 | 34 | NM | 38 |
| Delta-decalactone | 7 | 38 | 34 | 38 | 28 | 41 | 11 | 38 |
| Delta-dodecalactone | 6 | 30 | 29 | 32 | 23 | 35 | 6 | 30 |
| C₆-C₁₀ fatty acid methyl ester | 1 | 6 | 19 | 20 | 19 | 24 | 2 | 26 |
| C₁₂-C₁₈ fatty acid methyl ester | 1 | 4 | 10 | 8 | 5 | 8 | 1 | 6 |
| Dimethyl decanamide | 3 | 48 | 31 | 29 | 22 | 33 | 8 | 42 |

| | Cyprocon- | | Fenbucon- | Tebucon- | Propicon- | Meta- | | Delta- | |
|---|---|---|---|---|---|---|---|---|---|
| Solvent | azole | Fluxapryoxad | azole | azole | azole | flumizone | Pinoxaden | methrin | Pendimethalin |
| Gamma-octalactone | 31 | 20 | 20 | 28 | >50 | NM | NM | NM | NM |
| Gamma-nonalactone | 26 | 13 | 19 | 26 | >50 | 23 | 15 | 13 | 19 |
| Beta-methyl-gamma-octalactone | NM | NM | NM | 25 | >50 | NM | NM | NM | NM |
| Gamma-decalactone | 24 | 14 | 15 | 22 | >50 | 19 | NM | 14 | 15 |
| Gamma-undecalactone | 17 | 11 | 13 | 22 | >50 | 16 | NM | 11 | 13 |
| Gamma-dodecalactone | 19 | NM | NM | 21 | >50 | NM | NM | NM | NM |
| Delta-decalactone | 31 | 20 | 15 | 32 | >50 | 29 | NM | 20 | 15 |
| Delta-dodecalactone | 28 | 15 | 15 | 28 | >50 | 21 | NM | 15 | 15 |
| C₆-C₁₀ fatty acid methyl ester | 7 | 1 | 2 | 6 | >50 | NM | NM | NM | NM |
| C₁₂-C₁₈ fatty acid methyl ester | 5 | 1 | 1 | 5 | >50 | 0 | 2 | NM | NM |
| Dimethyl decanamide | 33 | 16 | 16 | 35 | >50 | 28 | 7 | NM | NM |

*NM = Not measured

TABLE 3.1.1
Attempted pesticide EC formulation using comparative solvent (C₆-C₁₀ fatty acid methyl ester)

| | | CE1 | CE2 | CE3 | CE4 | CE5 | CE6 |
|---|---|---|---|---|---|---|---|
| Component | | | | | | | |
| Tebuconazole | | 20 | | | | | |
| Oxyfluorfen | | | 27 | | | | |
| Difenoconazole | | | | 25 | | | |
| Trifloxystrobin | | | | | 25 | | |
| Pyraclostrobin | | | | | | 25 | |
| Flufenacetate | | | | | | | 25 |
| Cyproconazole | | | | | | | |
| Prothioconazole | | | | | | | |
| Fenbuconazole | | | | | | | |
| Metaflumizone | | | | | | | |
| Pinoxaden | | | | | | | |
| C₆-C₁₀ fatty acid methyl ester | | 68 | 61 | 63 | 63 | 63 | 63 |
| Emulsifier 2 | | 8 | 8 | | | | |
| Emulsifier 3 | | | | | 8 | 8 | 8 |
| Emulsifier 4 | | | | 8 | | | |
| Emulsifier 5 | | 4 | 4 | 4 | 4 | 4 | 4 |
| Emulsifier 6 | | | | | | | |
| Emulsifier 7 | | | | | | | |
| EC Appearance | | Unstable, | Unstable, | Unstable, | Unstable, | Unstable, | Unstable, |
| | | separates | separates | separates | separates | separates | separates |
| Emulsion Properties | | | | | | | |
| Blooming | | NM** | NM** | NM** | NM** | NM** | NM** |
| Emulsion 1 h | mL | NM | NM | NM | NM | NM | NM |
| Emulsion 2 h | cream or | NM | NM | NM | NM | NM | NM |
| Emulsion 4 h | sediment | NM | NM | NM | NM | NM | NM |
| Emulsion 24 h | | NM | NM | NM | NM | NM | NM |
| Re-emulsification 30 min | | NM | NM | NM | NM | NM | NM |

| | | CE7 | CE8 | CE9 | CE10 | CE11 |
|---|---|---|---|---|---|---|
| Component | | | | | | |
| Tebuconazole | | | | | | |
| Oxyfluorfen | | | | | | |
| Difenoconazole | | | | | | |
| Trifloxystrobin | | | | | | |
| Pyraclostrobin | | | | | | |
| Flufenacetate | | | | | | |
| Cyproconazole | | 20 | | | | |
| Prothioconazole | | | 25 | | | |
| Fenbuconazole | | | | 10 | | |
| Metaflumizone | | | | | 15 | |
| Pinoxaden | | | | | | 10 |
| C₆-C₁₀ fatty acid methyl ester | | 65 | 60 | 75 | 70 | 75 |
| Emulsifier 2 | | 8 | | | 8 | 8 |
| Emulsifier 3 | | | 8 | 8 | | |
| Emulsifier 4 | | | | | | |
| Emulsifier 5 | | 4 | | 4 | 4 | 4 |
| Emulsifier 6 | | | 4 | | | |
| Emulsifier 7 | | 3 | 3 | 3 | 3 | 3 |
| EC Appearance | | Unstable, | Unstable, | Unstable, | Unstable, | Unstable, |
| | | separates | separates | separates | separates | separates |
| Emulsion Properties | | | | | | |
| Blooming | | NM** | NM** | NM** | NM** | NM** |
| Emulsion 1 h | mL | NM | NM | NM | NM | NM |
| Emulsion 2 h | cream or | NM | NM | NM | NM | NM |
| Emulsion 4 h | sediment | NM | NM | NM | NM | NM |
| Emulsion 24 h | | NM | NM | NM | NM | NM |
| Re-emulsification 30 min | | NM | NM | NM | NM | NM |

* Emulsion tests conducted in CIPAC D water (342 ppm hardness, 4:1 Ca:Mg, pH 6-7) at 21° C.
**NM = not measured, due to instability of EC

TABLE 3.1.2
Pesticide EC formulation using gamma-nonalactone in emulsion testing

| | | IE1 | IE2 | IE3 | IE4 | IE5 | IE6 | IE7 | IE8 | IE9 | IE10 | IE11 |
|---|---|---|---|---|---|---|---|---|---|---|---|---|
| Component | | | | | | | | | | | | |
| Tebuconazole | | 20 | | | | | | | | | | |
| Oxyfluorfen | | | 27 | | | | | | | | | |
| Difenoconazole | | | | 25 | | | | | | | | |
| Trifloxystrobin | | | | | 25 | | | | | | | |
| Pyraclostrobin | | | | | | 25 | | | | | | |
| Flufenacetate | | | | | | | 25 | | | | | |
| Cyproconazole | | | | | | | | 20 | | | | |
| Prothioconazole | | | | | | | | | 25 | | | |
| Fenbuconazole | | | | | | | | | | 10 | | |
| Metaflumizone | | | | | | | | | | | 15 | |
| Pinoxaden | | | | | | | | | | | | 10 |
| Gamma-Nonalactone | | 68 | 61 | 63 | 63 | 63 | 63 | 65 | 60 | 75 | 70 | 75 |
| Emulsifier 2 | | 8 | 8 | | | | | 8 | | | 8 | 8 |
| Emulsifier 3 | | | | | 8 | 8 | 8 | | 8 | 8 | | |
| Emulsifier 4 | | | | 8 | | | | | | | | |
| Emulsifier 5 | | 4 | 4 | 4 | 4 | 4 | 4 | 4 | | 4 | 4 | 4 |
| Emulsifier 6 | | | | | | | | | 4 | | | |
| Emulsifier 7 | | | | | | | | 3 | 3 | 3 | 3 | 3 |
| EC Appearance | | Clear, | Clear, | Clear, | Cloudy, | Clear, | Cloudy, | Cloudy, | Clear, | Cloudy, | Clear, | Clear, |
| | | Stable | Stable | Stable | Stable | Stable | Stable | Stable | Stable | Stable | Stable | Stable |
| Emulsion Properties | | | | | | | | | | | | |
| Blooming | | 2 | 2 | 2 | 2 | 2 | 2 | 2 | 2 | 1 | 2 | 1 |
| Emulsion 1 h | mL | <0.1 | <0.1 | <0.1 | <0.1 | 0.2 | <0.1 | <0.1 | 0.3 | <0.1 | <0.1 | <0.1 |
| Emulsion 2 h | cream or | <0.1 | <0.1 | <0.1 | <0.1 | 0.3 | <0.1 | <0.1 | 0.5 | <0.1 | <0.1 | <0.1 |
| Emulsion 4 h | sediment | <0.1 | <0.1 | 0.1 | 0.1 | 0.5 | <0.1 | <0.1 | 0.7 | <0.1 | <0.1 | <0.1 |
| Emulsion 24 h | | 0.3 | <0.1 | 0.2 | 0.3 | 1.3 | 0.3 | 0.3 | 1.5 | 0.5 | <0.1 | 0.7 |
| Re-emulsification 30 min | | <0.1 | <0.1 | <0.1 | 0.1 | 0.3 | <0.1 | <0.1 | 0.2 | <0.1 | <0.1 | <0.1 |

* Emulsion tests conducted in CIPAC D water (342 ppm hardness, 4:1 Ca:Mg, pH 6-7) at 21° C.

### Table 3.1.3 Pesticide Formulation Emulsion Low Temperature Re-Circulation Test Using Gamma-Nonalactone

A low-temperature emulsion re-circulation test was conducted to assess the stability of the emulsion under field application conditions. Herein, a 5 L temperature-controlled vessel isothermally maintained at 4° C. containing 3 L of pesticide emulsion at 0.5% w/w emulsifiable concentrate was prepared. The emulsion contains 3 L CIPAC D water and 15 g of emulsifiable concentrate, resulting in an emulsion concentration of 0.5% w/w. The resulting emulsion was pumped through a metal filter with a 140 μm pore size attached to the temperature-controlled vessel at a flow rate of 1 L/min for 6 h at 4° C., wherein the pressure was continually monitored. A perfectly stable emulsion maintains a pressure <1.0 bar throughout the 6 h re-circulation period, and the filter after 6 h re-circulation was removed and dried, with a total collected solid material <100 mg measured.

| | IE1 | IE3 |
|---|---|---|
| Vessel pressure after 6 h re-circulation [bar] | 0.3 | 0.3 |
| Weight of collected dried filter | 59.9 | 1.6 |
| material after 6 h [mg] | | |

No evaluation was possible for any of the comparative examples, since the unstable emulsions would have blocked the equipment.

TABLE 3.2
Pesticide EC formulation using beta-methyl-gamma-octalactone
or gamma-undecalactone in emulsion testing

| | | IE12 | IE13 | IE14 | IE15 | IE16 | IE17 |
|---|---|---|---|---|---|---|---|
| Component | | | | | | | |
| Tebuconazole | | 20 | | | | | |
| Oxyfluorfen | | | 20 | | | | |
| Difenoconazole | | | | 27 | | | |
| Trifloxystrobin | | | | | 20 | | |
| Prothioconazole | | | | | | 20 | |
| Propioconazole | | | | | | | 20 |
| Flufenacetate | | | | | | | |
| Beta-methyl-gamma-octalactone | | 65 | 65 | 58 | 65 | 65 | 65 |
| Gamma-undecalactone | | | | | | | |
| Emulsifier 1 | | 8 | | | | | |
| Emulsifier 2 | | | | 8 | 8 | 8 | |
| Emulsifier 3 | | | 8 | | | | 8 |
| Emulsifier 5 | | 4 | 4 | 4 | 4 | 4 | |
| Emulsifier 6 | | | | | | | 4 |
| Emulsifier 7 | | 3 | 3 | 3 | 3 | 3 | 3 |
| EC Appearance | | Clear, | Clear, | Cloudy | Clear, | Cloudy, | Clear, |
| | | Stable | Stable | stable | stable | stable | stable |
| Emulsion Properties | | | | | | | |
| Blooming | | 2 | 2 | 2 | 2 | 2 | 2 |
| Emulsion 1 h | mL | <0.1 | <0.1 | <0.1 | <0.1 | <0.1 | 0.1 |
| Emulsion 2 h | cream or | <0.1 | 0.1 | 0.1 | 0.1 | <0.1 | 0.3 |
| Emulsion 4 h | sediment | <0.1 | 0.2 | 0.1 | 0.2 | 0.2 | 0.5 |
| Emulsion 24 h | | <0.1 | 0.7 | 0.1 | 1.0 | 0.3 | 1.0 |
| Re-emulsification 30 min | | <0.1 | <0.1 | <0.1 | <0.1 | <0.1 | 0.2 |
| | | IE18 | IE19 | IE20 | IE21 | IE22 | IE23 |
| Component | | | | | | | |
| Tebuconazole | | 20 | | | | | |
| Oxyfluorfen | | | 25 | | | | |
| Difenoconazole | | | | 26 | | | |
| Trifloxystrobin | | | | | 15 | | |
| Prothioconazole | | | | | | 20 | |
| Propioconazole | | | | | | | |
| Flufenacetate | | | | | | | 25 |
| Beta-methyl-gamma-octalactone | | | | | | | |
| Gamma-undecalactone | | 70 | 63 | 62 | 70 | 68 | 60 |
| Emulsifier 1 | | | | | | | |
| Emulsifier 2 | | 8 | 8 | 8 | 8 | 8 | 8 |
| Emulsifier 3 | | | | | | | |
| Emulsifier 5 | | | 4 | 4 | 4 | 4 | 4 |
| Emulsifier 6 | | 4 | | | | | |
| Emulsifier 7 | | | 3 | | 3 | | 3 |
| EC Appearance | | Clear | Clear, | Clear, | Clear, | Clear, | Clear, |
| | | Stable | Stable | Stable | Stable | Stable | Stable |
| Emulsion Properties | | | | | | | |
| Blooming | | 2 | 2 | 2 | 2 | 2 | 2 |
| Emulsion 1 h | mL | <0.1 | <0.1 | <0.1 | <0.1 | 0.1 | <0.1 |
| Emulsion 2 h | cream or | <0.1 | <0.1 | <0.1 | <0.1 | 0.1 | <0.1 |
| Emulsion 4 h | sediment | <0.1 | <0.1 | <0.1 | <0.1 | 0.1 | <0.1 |
| Emulsion 24 h | | 1.0 | 0.2 | <0.1 | <0.1 | 0.3 | <0.1 |
| Re-emulsification 30 min | | <0.1 | <0.1 | <0.1 | <0.1 | <0.1 | <0.1 |

* Emulsion tests conducted in CIPAC D water (342 ppm hardness, 4:1 Ca:Mg, pH 6-7) at 21° C.

TABLE 3.3
Pesticide EC formulation using gamma-decalactone in emulsion testing

| | | IE24 | IE25 | IE26 | IE27 | IE28 | IE29 | IE30 | IE31 | IE32 |
|---|---|---|---|---|---|---|---|---|---|---|
| Component | | | | | | | | | | |
| Tebuconazole | | 20 | | | | | | | | |
| Oxyfluorfen | | | 25 | | | | | | | |
| Difenoconazole | | | | 25 | | | | | | |
| Prothioconazole | | | | | 20 | | | | | |
| Flufenacetate | | | | | | 25 | | | | |
| Trifloxystrobin | | | | | | | 20 | | | |
| Cyproconazole | | | | | | | | 20 | | |
| Propiconazole | | | | | | | | | 25 | |
| Pinoxaden | | | | | | | | | | 5 |
| Gamma-decalactone | | 68 | 63 | 63 | 65 | 60 | 65 | 68 | 60 | 80 |
| Emulsifier 2 | | 8 | 8 | | 8 | 8 | 8 | 8 | | 8 |
| Emulsifier 3 | | | | | | | | | 8 | |
| Emulsifier 4 | | | | 8 | | | | | | |
| Emulsifier 5 | | 4 | 4 | 4 | 4 | 4 | 4 | 4 | | 4 |
| Emulsifier 6 | | | | | | | | | 4 | |
| Emulsifier 7 | | | | | 3 | 3 | 3 | | 3 | 3 |
| EC Appearance | | Clear, | Clear, | Clear, | Clear, | Clear, | Cloudy, | Clear, | Clear, | Clear, |
| | | Stable | Stable | Stable | Stable | Stable | Stable | Stable | Stable | Stable |
| Emulsion Properties | | | | | | | | | | |
| Blooming | | 2 | 2 | 2 | 2 | 2 | 1 | 2 | 2 | 1 |
| Emulsion 1 h | mL | <0.1 | <0.1 | <0.1 | 0.2 | <0.1 | <0.1 | <0.1 | 0.2 | <0.1 |
| Emulsion 2 h | cream or | <0.1 | <0.1 | <0.1 | 0.3 | <0.1 | <0.1 | <0.1 | 0.2 | <0.1 |
| Emulsion 4 h | sediment | <0.1 | <0.1 | 0.1 | 0.5 | <0.1 | <0.1 | <0.1 | 0.3 | <0.1 |
| Emulsion 24 h | | <0.1 | <0.1 | 0.3 | 1.5 | <0.1 | <0.1 | <0.1 | 0.7 | 0.5 |
| Re-emulsification 30 min | | <0.1 | <0.1 | <0.1 | 0.2 | <0.1 | <0.1 | <0.1 | 0.1 | <0.1 |

* Emulsion tests conducted in CIPAC D water (342 ppm hardness, 4:1 Ca:Mg, pH 6-7) at 21° C.

TABLE 3.4
Pesticide EC formulation using delta-decalactone or delta-dodecalactone in emulsion testing

| | | IE33 | IE34 | IE35 | IE36 | IE37 | IE38 | IE39 |
|---|---|---|---|---|---|---|---|---|
| Component | | | | | | | | |
| Tebuconazole | | 25 | | | | | | |
| Difenoconazole | | | 27 | | | | | |
| Prothioconazole | | | | 20 | | | | |
| Flufenacetate | | | | | 25 | | | |
| Cyproconazole | | | | | | 25 | | |
| Propiconazole | | | | | | | 20 | |
| Trifloxystrobin | | | | | | | | 20 |
| Pinoxaden | | | | | | | | |
| Metaflumizone | | | | | | | | |
| Delta-decalactone | | 63 | 61 | 65 | 60 | 60 | 65 | 65 |
| Delta-dodecalactone | | | | | | | | |
| Emulsifier 1 | | 8 | | | | | | |
| Emulsifier 2 | | | 8 | 8 | 8 | 8 | 8 | |
| Emulsifier 3 | | | | | | | | 8 |
| Emulsifier 5 | | 4 | 4 | 4 | 4 | 4 | 4 | 4 |
| Emulsifier 7 | | | | 3 | 3 | 3 | 3 | 3 |
| EC Appearance | | Cloudy, | Clear, | Clear, | Clear, | Clear, | Clear, | Cloudy, |
| | | Stable | Stable | Stable | Stable | Stable | Stable | Stable |
| Emulsion Properties | | | | | | | | |
| Blooming | | 2 | 2 | 2 | 2 | 2 | 2 | 2 |
| Emulsion 1 h | mL | 0.1 | <0.1 | 0.1 | <0.1 | 0.2 | 0.2 | <0.1 |
| Emulsion 2 h | cream or | 0.1 | <0.1 | 0.1 | <0.1 | 0.3 | 0.2 | <0.1 |
| Emulsion 4 h | sediment | 0.2 | <0.1 | 0.1 | <0.1 | 0.5 | 0.3 | <0.1 |
| Emulsion 24 h | | 1.0 | 0.1 | 1.0 | <0.1 | 1.5 | 0.7 | <0.1 |
| Re-emulsification 30 min | | 0.2 | <0.1 | 0.1 | <0.1 | 0.1 | <0.1 | <0.1 |
| | | IE40 | IE41 | IE42 | IE43 | IE44 | IE45 | IE46 |
| Component | | | | | | | | |
| Tebuconazole | | | | 20 | | | | |
| Difenoconazole | | | | | 27 | | | |
| Prothioconazole | | | | | | 20 | | |
| Flufenacetate | | | | | | | | |
| Cyproconazole | | | | | | | | |
| Propiconazole | | | | | | | 20 | |
| Trifloxystrobin | | | | | | | | 20 |
| Pinoxaden | | 10 | | | | | | |
| Metaflumizone | | | 15 | | | | | |
| Delta-decalactone | | 75 | 70 | | | | | |
| Delta-dodecalactone | | | | 65 | 58 | 65 | 65 | 65 |
| Emulsifier 1 | | | | 8 | | | | |
| Emulsifier 2 | | 8 | | | 8 | 8 | 8 | 8 |
| Emulsifier 3 | | | 8 | | | | | |
| Emulsifier 5 | | 4 | 4 | 4 | 4 | 4 | 4 | 4 |
| Emulsifier 7 | | 3 | 3 | 3 | 3 | 3 | 3 | 3 |
| EC Appearance | | Clear, | Clear, | Clear, | Clear, | Clear, | Clear, | Cloudy, |
| | | Stable | Stable | stable | stable | stable | stable | stable |
| Emulsion Properties | | | | | | | | |
| Blooming | | 1 | 1 | 2 | 2 | 2 | 2 | 2 |
| Emulsion 1 h | mL | <0.1 | <0.1 | <0.1 | <0.1 | 0.1 | <0.1 | <0.1 |
| Emulsion 2 h | cream or | <0.1 | <0.1 | <0.1 | <0.1 | 0.1 | <0.1 | <0.1 |
| Emulsion 4 h | sediment | <0.1 | <0.1 | <0.1 | 0.1 | 0.1 | <0.1 | <0.1 |
| Emulsion 24 h | | <0.1 | <0.1 | 1.0 | 0.5 | 0.7 | <0.1 | <0.1 |
| Re-emulsification 30 min | | <0.1 | <0.1 | <0.1 | <0.1 | <0.1 | <0.1 | <0.1 |

* Emulsion tests conducted in CIPAC D water (342 ppm hardness, 4:1 Ca:Mg, pH 6-7) at 21° C.

As can be seen from IE1 to IE46 in Tables 3.1.1 to 3.4, a wide range of agrochemically active compounds (i.e. pesticides) can be provided as emulsifiable concentrates for application onto crops. Many of the emulsifiable concentrates exemplified in the above tables, especially those containing prothioconazole, are notoriously insoluble in typical EC solvents, as can be seen from CE1 to CE11.

### Example 4: Rate of Penetration Measured by Fluorescence Index Enhancement

The improved penetration of pesticidal active ingredients into plants is a key lever to improve the biological efficacy of the formulation. Certain adjuvants can enable the improved penetration efficiency of active ingredients, which can significantly improve the activity of the formulation, resulting in either higher performance at elevated dosage rates or standard performance at lower dosage rates.

The effective rate of penetration enhancement of PS II inhibitors using selected adjuvants into plant leaves can be monitored using chlorophyll fluorescence methods. PS II inhibitors effectively block the chlorophyll photosynthetic pathways within the leaf, resulting in enhanced fluorescence from the non-adsorbed incident light. The resulting emitted light can be measured at selected time intervals, enabling the determination of the rate of uptake of the PS II inhibitor and thus penetration effect of the selected adjuvant.

The following experiments were on the broadleaf weed Abutilon theophrasti (EPPO code ABUTH) at a Biologische Bundesanstalt, Bundessortenamt und Chemische Industrie (BBCH) growth stage 13 to 14.

The penetration experiments are conducted via the deposition of two droplets (5 μl) of the herbicide/emulsifier/lactone-based solvent formulation onto the leaf surface. The droplets are allowed to stand on the leaf surface for 1 h, after which a fluorescence image of the exposed leaf surface is recorded using the PAM chlorophyll fluorescence imaging system (Imaging PAM, Heinz-Walz GmbH, Germany). The resulting “Total Fluorescence” and “Fluorescence Area” are then quantified via the analysis of the recorded fluorescence image using image analysis software. This enables the calculation of the “Fluorescence Index”:

$$Fluorescence Index = Total Fluorescence \times Fluorescence Area$$

The “Fluorescence Index” is a therefore a direct measurement of the penetration of the active ingredient into the plant leaf and can thus be used to measure enhanced penetration via the use of selected adjuvants. Identical experiments are conducted on 7 further leaves using the same formulation to account for biological variability and experimental error.

TABLE 4.1
Formulation applied to leaf surface

| Component | Concentration [% w/w] |
|---|---|
| Na Bentazone | 0.64 |
| Emulsifier | 0.1 |
| (Emulsifier 2:Emulsifier 5 | |
| 3:1 w/w %) | |
| Lactone-based solvent | 0.9 |
| CIPAC D Water | 98.36 |

The results of these tests are summarised in Table 4.2.

TABLE 4.2
Summary of the measured Fluorescence Index enhancement
upon using various lactone-based solvents

| | Formulation | | Fluores- |
|---|---|---|---|
| | Content | | ence |
| Component | (plus water)* | Molecular formula | Index |
| None (only water | Na B | — | 2.92 |
| control) | | | |
| Emulsifier (control) | Na B + E | — | 3.96 |
| gamma-valerolactone | Na B + E + S | C₅H₈O₂ | 4.85 |
| gamma-hexalactone | Na B + E + S | C₆H₁₀O₂ | 6.11 |
| gamma-octalactone | Na B + E + S | C₈H₁₄O₂ | 8.80 |
| gamma-nonalactone | Na B + E + S | C₉H₁₆O₂ | 16.44 |
| gamma-decalactone | Na B + E + S | C₁₀H₁₈O₂ | 14.13 |
| gamma-undecalactone | Na B + E + S | C₁₁H₂₀O₂ | 11.67 |
| delta-valerolactone | Na B + E + S | C₅H₈O₂ | 6.17 |
| delta-decalactone | Na B + E + S | C₁₀H₁₈O₂ | 9.66 |
| delta-dodecalactone | Na B + E + S | C₁₂H₂₂O₂ | 15.21 |

*Na B = sodium bentazone, E = Emulsifier, S = solvent

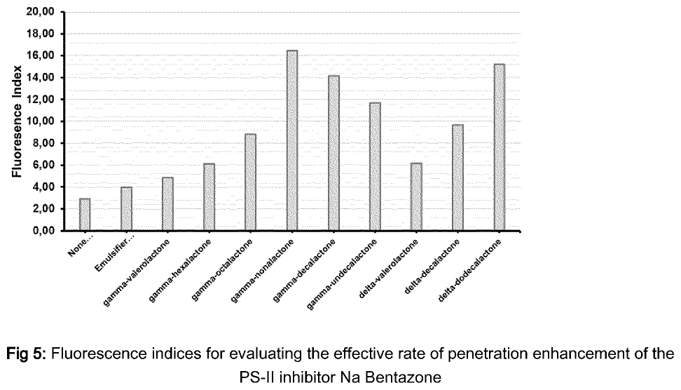

The Fluorescence indices are represented graphically in FIG. 5.

As can be seen from the data in Table 4.2/FIG. 5, the use of a lactone-based solvent in the emulsions improves the penetration of Na Bentazone into the leaf in all cases. The effects are, however, most pronounced for lactone solvents having at least 8 carbon atoms, peaking at 9 carbon atoms for the gamma-lactones. For the delta-lactones, the penetration continues to improve at least as far as 12 carbon atoms. Thus, lactone solvents having at least 8 carbon atoms represent a particularly preferred embodiment of the present invention.

### Example 5: Phytotoxicity Determination on Soya

Soya plants grown under standard greenhouse conditions in the growth stage 13 were treated with aqueous emulsions in a spray cabin. The resulting plant spray dosage represented an application rate of 200 L/ha of 1% w/w emulsion, corresponding to the application of 2 L/ha of the emulsifiable concentrate. The emulsifiable concentrate contains 90% w/w solvent and 10% w/w emulsifier (emulsifier mix 75% w/w castor oil ethoxylate and 25% w/w calcium dodecylbenzenesulfate). The experimental period lasted 14 days, during which time the Soya plants were given optimum watering, nutrients, and light.

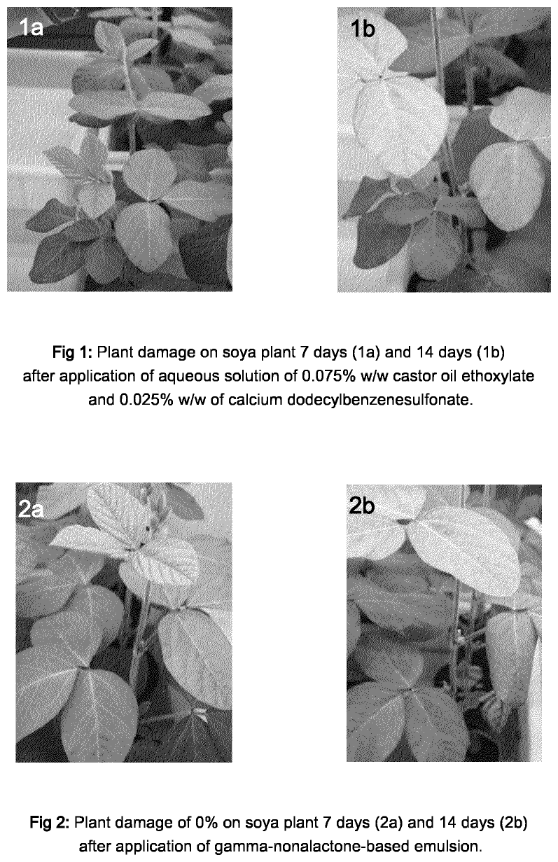

Solvent phytotoxicity was evaluated via visual examination on a scale of 0% to 100%, relative to plants treated with an aqueous solution of 0.075% w/w castor oil ethoxylate and 0.025% w/w of calcium dodecylbenzenesulfonate (see FIG. 1). Hereby, 0% represents no plant damage, with no difference between treated and untreated plants. An assessment of 1 to 10% phytotoxicity is the limit of acceptable plant damage by farmers. A phytotoxicity level from 11 to 30% represents moderate damage, between 31% and 60% high damage, above 61% very high damage and a rating of 100% representing complete plant destruction.

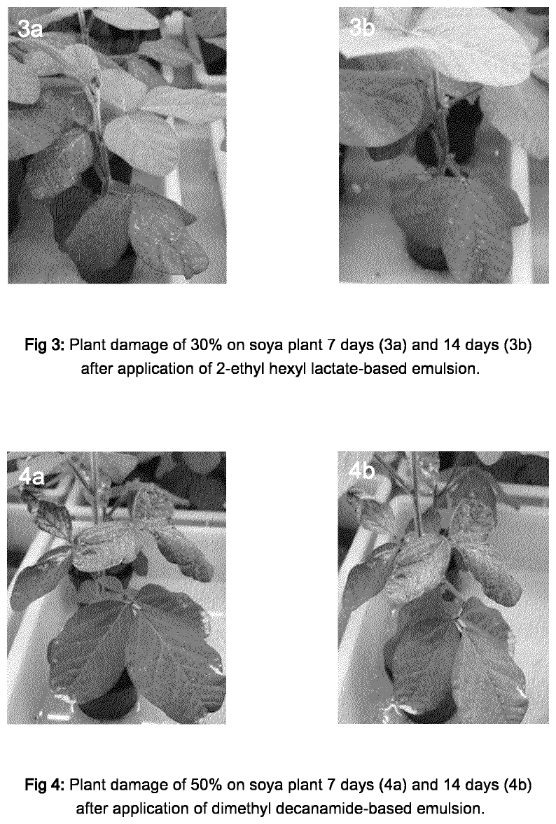

As a plant phytotoxicity of 0% was observed for the inventive gamma-nonalactone solvent (see FIG. 2), in can be stated that gamma-nonalactone is completely selective and non-phytotoxic. On the other hand, the application of the non-inventive solvents 2-ethyl hexyl lactate and dimethyl decanamide results in 30% and 50% phytotoxicity after 14 days respectively (see FIGS. 3 and 4).

The inventive solvents have no or almost no phytotoxic effects, and therefore can be used in agricultural formulations for reducing plant phytotoxicity in such compositions.

1. An emulsifiable concentrate (EC) comprising one or more pesticides, one or more emulsifiers and one or more solvents, wherein at least one of the one or more solvents has a structure according to formula (I): 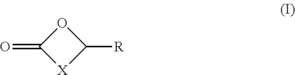
wherein X is selected from the group consisting of —CR′₂CR′₂—, —CR′═CR′—, —CR′₂CR′₂CR′₂—, and —CR′═CR′CR′₂—,
R is selected from the group consisting of linear and branched C₁ to C₁₅ alkyl or alkenyl groups, and each instance of R′ is independently selected from the group consisting of H, Me and Et.

2. The emulsifiable concentrate (EC) according to claim 1, wherein X is selected from the group consisting of —CH₂CH₂—, —CH₂CH(Me)—, and —CH₂CH₂CH₂—.

3. The emulsifiable concentrate (EC) according to claim 1, wherein at least one of the solvent(s) having a structure according to formula (I) has 8 or more carbon atoms.

4. The emulsifiable concentrate (EC) according to claim 1, wherein X is —CH₂CH₂— or —CH₂CH(Me).

5. The emulsifiable concentrate (EC) according to claim 1, wherein X is —CH₂CH₂CH₂—.

6. The emulsifiable concentrate (EC) according to claim 1, wherein at least one of the one or more pesticides is selected from the group consisting of azoxystrobin, prothioconazole, pyraclostrobin, oxyfluorfen, difenoconazole, trifloxystrobin, propiconazole, cyproconazole, flufenacetate, epoxiconazole, fluxapyroxad, fenbuconazole, tebuconazole, metaflumizone, pinoxaden, deltamethrin, and pendimethalin.

7. The emulsifiable concentrate (EC) according to claim 1, wherein at least one of the solvent(s) having a structure according to formula (I) has a water solubility of less than 2.0% w/w.

8. The emulsifiable concentrate (EC) according to claim 1, wherein the total pesticide content is in the range from 5 to 70% w/w, relative to the total weight of the emulsifiable concentrate (EC).

9. The emulsifiable concentrate (EC) according to claim 1, wherein the total content of solvents with a structure according to formula (I) is in the range from 10 to 85% w/w, relative to the total weight of the emulsifiable concentrate (EC).

10. The emulsifiable concentrate (EC) according to claim 1, containing one or more non-ionic emulsifier(s) and optionally one or more anionic emulsifier(s).

11. The emulsifiable concentrate (EC) according to claim 1, wherein the emulsifiable concentrate (EC) forms a stable emulsion when 5.0 mL of said emulsifiable concentrate (EC) is combined with 95.0 mL of water and homogenized, wherein a stable emulsion is defined as an emulsion having less than or equal to 1.5 mL of cream or sediment, 24 hours after formation of said emulsion.

12. An emulsion-in-water (EW) formulation comprising an aqueous phase and a non-aqueous phase, wherein the non-aqueous phase is the emulsifiable concentrate (EC) according to claim 1, wherein the emulsion-in-water (EW) formulation achieves improved penetration of the one or more pesticides into plants relative to comparable emulsion-in-water formulations using different solvent(s) and/or no solvent.

13. An emulsion-in-water (EW) formulation comprising an aqueous phase and a non-aqueous phase, wherein the non-aqueous phase is the emulsifiable concentrate (EC) according to claim 1.

14. A method of using a compound having a structure according to formula (I) 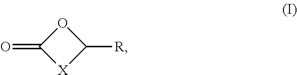
wherein X is selected from the group consisting of —CR′₂CR′₂—, —CR′═CR′—, —CR′₂CR′₂CR′₂—, and —CR′═CR′CR′₂—,
R is selected from the group consisting of linear and branched C₁ to C₁₅ alkyl or alkenyl groups, and each instance of R′ is independently selected from the group consisting of H, Me and Et, the method comprising using the compound as a solvent in an agrochemical emulsifiable concentrate.

15. A method of using the emulsion-in-water (EW) formulation according to claim 13, the method comprising using the emulsion-in-water (EW) formulation for treating plants, thereby maintaining plant health, without causing plant damage.

16. The emulsifiable concentrate (EC) according to claim 4, wherein at least one of the one or more solvents is selected from the group consisting of gamma-octalactone, gamma-nonalactone, gamma-decalactone, gamma-undecalactone, gamma-dodecalactone, beta-methyl-gamma-octalactone, delta-methyl-gamma-octalactone, and beta,delta-dimethyl-gamma-octalactone.

17. The emulsifiable concentrate (EC) according to claim 5, wherein at least one of the one or more solvents is selected from the group consisting of delta-nonalactone, delta-decalactone, delta-dodecalactone, and delta-tridecalactone.

18. The emulsifiable concentrate (EC) according to claim 1, wherein at least one of the solvent(s) having a structure according to formula (I) has a water solubility of less than 1.0% w/w.

19. The emulsifiable concentrate (EC) according to claim 1, wherein the total pesticide content is in the range from 10 to 65% w/w, relative to the total weight of the emulsifiable concentrate (EC).

20. The emulsifiable concentrate (EC) according to claim 10, wherein at least one non-ionic emulsifier is a castor oil ethoxylate, and wherein at least one anionic emulsifier is an alkyl benzene sulfonate.
